(19) United States
(12) Patent Application Publication
(10) Pub. No.: US 2004/0026663 A1
(43) Pub. Date: Feb. 12, 2004

(54) Polynuclear metal complexes as phosphorescence emitters in electroluminescent layer arrangements

(76) Inventors: Helmut-Werner Heuer, Krefeld (DE); Rolf Wehrmann, Krefeld (DE); Armin Sautter, Krefeld (DE)

Correspondence Address: BAYER CHEMICALS CORPORATION, PATENT DEPARTMENT, 100 BAYER ROAD, PITTSBURGH, PA, 15205-9741, US

(21) Appl. No.: 10/635,842

(22) Filed: Aug. 6, 2003

(30) Foreign Application Priority Data
Aug. 9, 2002 (DE) 10236538.5

(51) Int. Cl. C09K 11/06; C07F 1/00

(52) U.S. Cl. 252/301.16; 428/690; 556/18

(57) ABSTRACT

The present invention relates to polynuclear metal complexes, a process for their preparation and their use as phosphorescence emitters in electroluminescent layer arrangements.

### BACKGROUND OF THE INVENTION

1. Field of the Invention

The present invention relates to polynuclear metal complexes, a process for their preparation and their use as phosphorescence emitters in electroluminescent layer arrangements.

2. Background of the Invention

Electroluminescent layer arrangements, also referred to below as electroluminescent arrangements or EL arrangements, have a wide range of uses, for example in optoelectronic applications, such as light-emitting diodes (LEDs) and in the production of screens or displays. Recently there has been increasing interest in emissive displays and display apparatuses, particularly those utilizing electrophosphorescence for increasing the luminous efficiency (cf. Baldo et al., Appl. Phys. Lett., Vol. 75, No. 1, 4, 1999; WO 00/70 655 A2, WO 01/415 12 A1).

The light emission in organic light-emitting diodes usually preferably takes place by fluorescence processes. The electroluminescence (EL) quantum efficiency of an arrangement comprising a fluorescent emitter is, however, limited by the low theoretical ratio of singlet excitons (25%) to triplet excitons (75%) which are formed by electron-hole recombination, since the light emission occurs only from excited singlet states. Triplet-based emission of light is known by the term phosphorescence (WO 00/70 655 A2). The advantage of phosphorescent emitters is that both the singlet and the triplet states contribute to the light emission, i.e. the internal quantum efficiency may be up to 100% since all excitons can be used for light emission.

The organic electroluminescence (EL) arrangements contain, as a rule, one or more layers of organic charge transport compounds in addition to the light-emitting layer. The basic structure in the sequence of the layers is as follows:

1 Support, substrate

2 Base electrode

3 Hole-injecting layer

4 Hole-transporting layer (=hole-conducting layer)

5 Light-emitting layer

6 Hole-blocking layer

7 Electron-transporting layer

8 Electron-injecting layer

9 Top electrode

10 Contacts

11 Covering, encapsulation.

The terms hole-transporting and hole-conducting are to be considered below to be identical in their meaning.

The layers 1 to 10 represent the electroluminescent arrangement. The layers 3 to 8 represent the electroluminescent element.

This structure describes the general case and may be simplified by omitting individual layers so that one layer performs several tasks. In the simplest case, an EL arrangement consists of two electrodes between which an organic layer which performs all functions—including the emission of light—is located.

Multilayer systems in LEDs can be built up by chemical vapour deposition (CVD) methods, in which the layers are applied successively from the gas phase, or by casting methods. The chemical vapour deposition methods are used in combination with the hole mask technique for the production of structured LEDs which use organic molecules as emitters. Owing to the higher process speeds and the smaller amounts of waste material produced and the associated cost saving, casting methods are generally preferred. The printing technique, in particular the inkjet technique, for structuring polymeric emitters is currently attracting a great deal of attention (Yang et al., Appl. Phys. Lett. 1998, 72 (21), 2660; WO 99/54936).

The efficiency of the electroluminescent arrangements has been substantially increased in recent years by incorporating phosphorescent dopants into a matrix. For the use of the bis(2-phenylpyridine)iridium(III) acetylacetonate [(ppy)₂Ir(acac)] complex as a dopant in EL arrangements, which complex has green phosphorescence, external EL efficiencies of 19% was determined (C. Adachi et al., J. Appl. Phys. 2001, 90, 5048). However, such high efficiencies have been realized to date only in multilayer arrangements which were produced by complicated chemical vapour deposition methods. The reasons for this are the moderate solubility of the iridium complexes used and their strong tendency to recrystallization, which is disadvantageous for application from solution. The much simpler and established processing from solution, for example by means of spin coating, casting methods or inkjet methods, would be desirable. WO 01/41512 A1 describes complexes as phosphorescence dopants, which, however, do not have sufficient solubility for an inkjet process.

Recently, soluble low molecular weight iridium complexes having sterically bulky fluorenyl-pyridine or fluorenyl-phenylpyridine ligands were synthesized, which complexes can be applied from solution but have only very low EL efficiencies of 0.1% in single-layer EL arrangements (J. C. Ostrowski et al., Chem. Commun. 2002, 784-785). By using these iridium complexes as dopants in a matrix, it was possible to increase the efficiencies to 8.8% (X. Gong et al., Adv. Mater. 2002, 14(8), 581-585). P. L. Burn et al., Appl. Phys. Lett. 2002, 80 (15), 2645-2647 and Y. Cao et al., Appl. Phys. Lett. 2002, 80 (12), 2045-2047 also describe iridium complexes which have improved solubility owing to substitution on the ligands. It was possible to apply these compounds together with a polymer matrix from solution by spin coating. However, a major disadvantage in the case of all these compounds is the enormous complexity of the synthesis in the preparation of the substituted ligands and the subsequent reaction to give iridium complexes, which generally takes place only with low yields (30-50%) and under drastic conditions (150-200° C.).

The object of the present invention was therefore to provide novel compounds which are suitable as phosphorescence emitters, can be easily prepared and can be applied from solution and which do not have the above mentioned disadvantages, for example, of a complicated ligand synthesis and of the strong tendency to recrystallization.

### SUMMARY OF THE INVENTION

The present invention relates to polynuclear metal complexes of the general formula (I)

(LₘMe-H_{L})ₙX_{L} (I)

in which

Me represents a transition metal, preferably represents a transition metal of the 6th to 8th subgroup, of the lanthanoid or actinoid group, particularly preferably represents platinum(II) or iridium(III),

L represents a bidentate chelate-forming ligand,

H_{L} represents a bidentate chelate-forming ligand which complexes the transition metal Me in a chelate-like manner and is additionally bonded to a linker X_{L},

X_{L} represents an n-functional linker and is covalently bonded to n auxiliary ligands H_{L},

n represents an integer from 2 to 6, preferably represents 2 or 3, and

m represents an integer from 1 to 3, preferably represents 1 or 2.

In the context of the invention, polynuclear metal complexes of the general formula (1) may be, for example, metal complexes of the following formulae I-1 to I-5

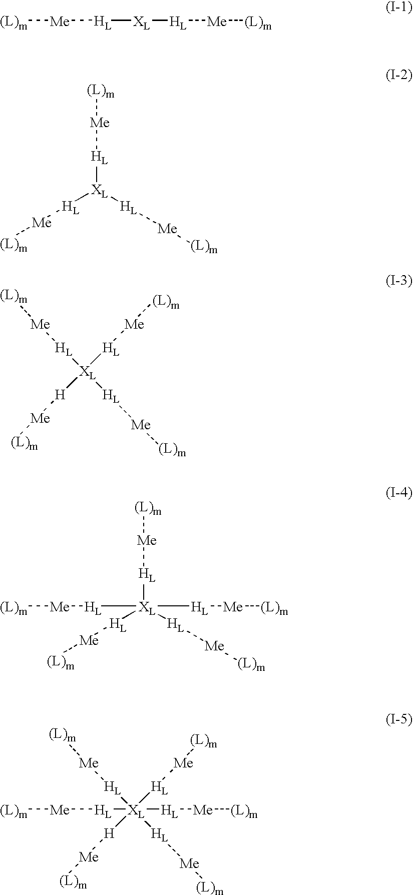

in which

Me, L, H_{L} or X_{L} and m have the above mentioned meaning.

### DETAILED DESCRIPTION OF THE INVENTION

The invention preferably relates to polynuclear metal complexes of the general formula (I) in which

L represents a bidentate chelate-forming ligand selected from the general formulae (II) to (XIX)

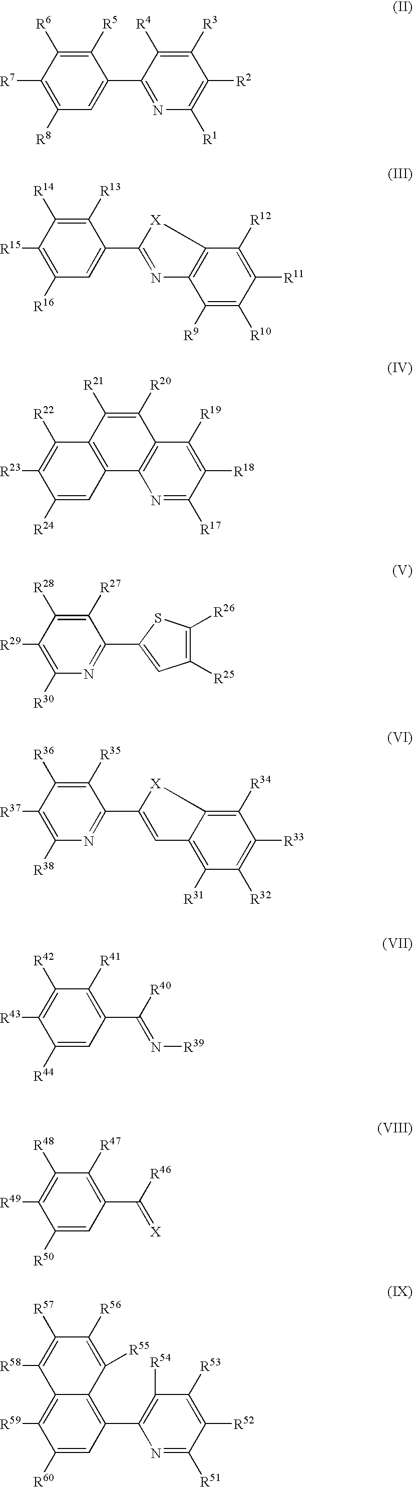

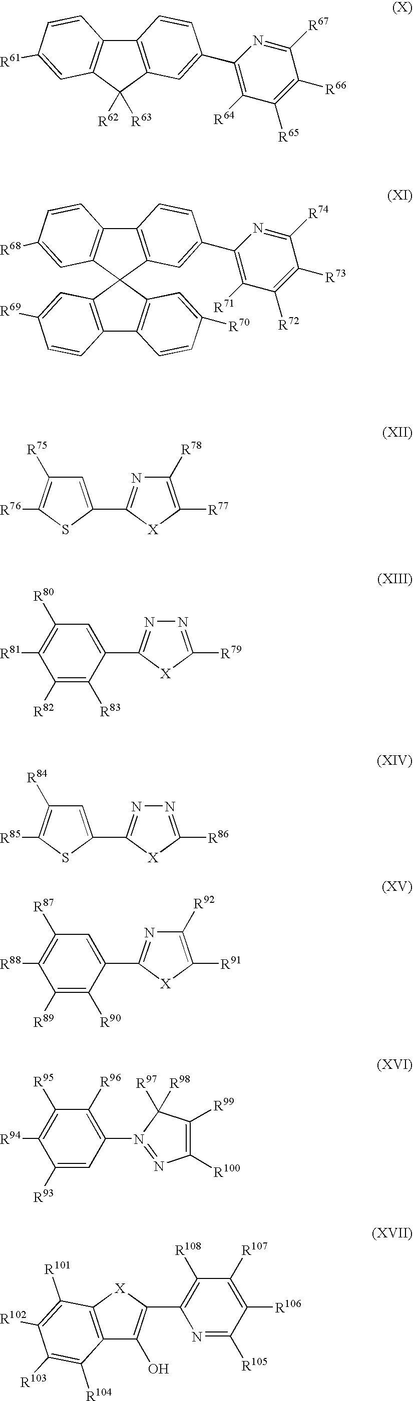

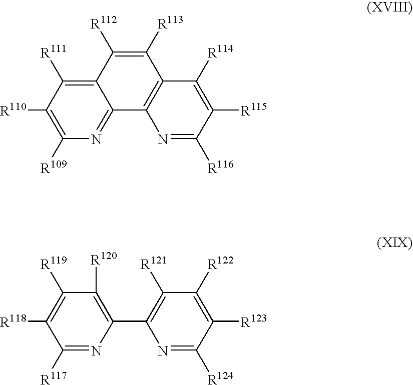

in which

X represents oxygen, sulphur, N-alkyl-or N—H,

R¹-R¹²⁴ are identical or different and, independently of one another, represent H, F, CF₃, a linear or branched C₁-C₂₂-alkyl group, a linear or branched C₁-C₂₂-alkoxy group, an optionally C₁-C₃₀-alkyl-substituted C₅-C₂₀-aryl unit and/or an optionally C₁-C₃₀-alkyl-substituted heteroaryl unit having 5 to 9 ring C atoms and 1 to 3 ring heteroatoms from the group consisting of nitrogen, oxygen and sulphur.

H_{L} represents a bidentate chelate-forming ligand selected from the general formulae (XX) to (XXX), which complexes the transition metal Me in a chelate-like manner and is bonded to the linker X_{L} via the linkage point marked with *,

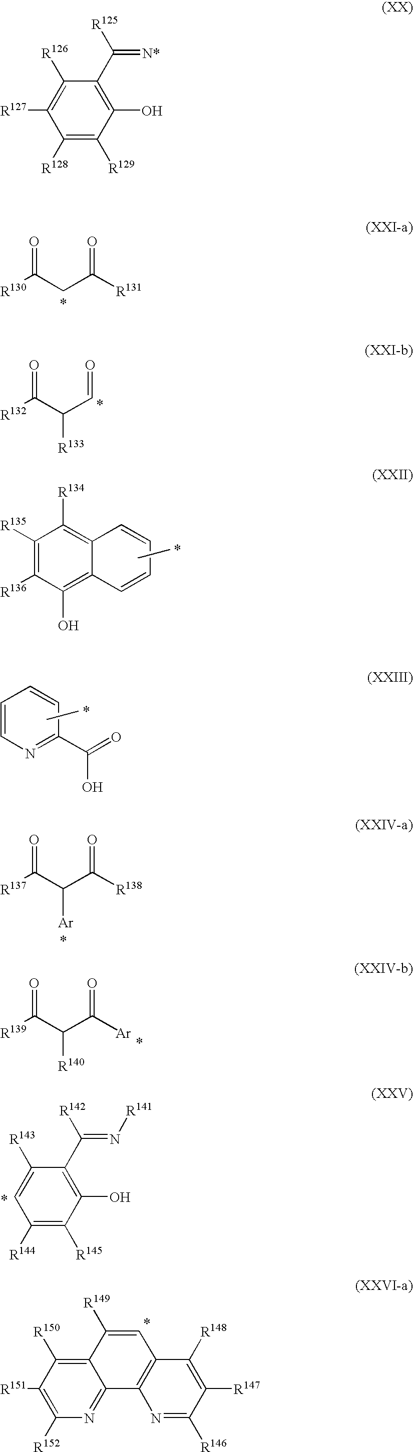

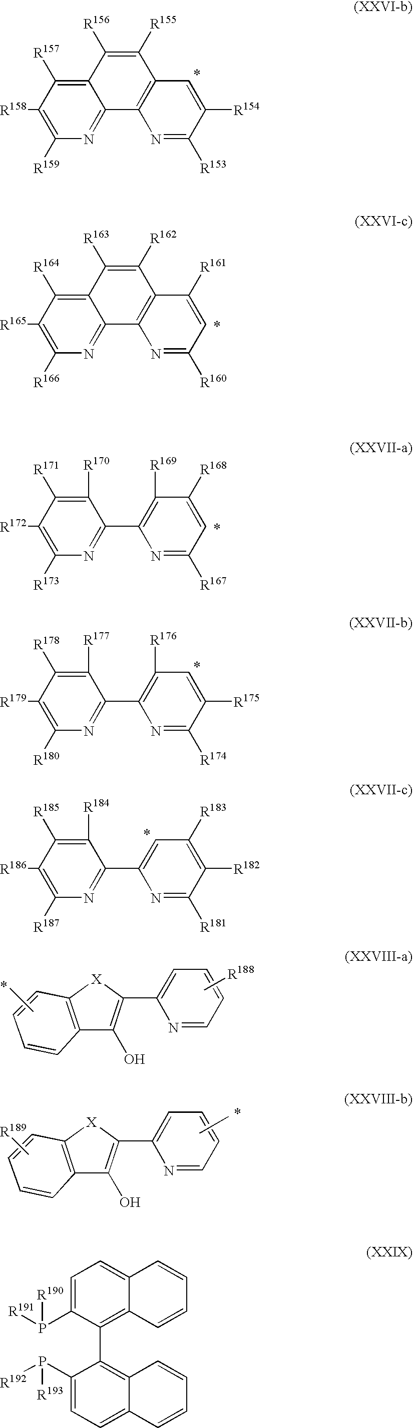

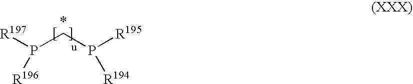

and

X represents oxygen, sulphur or N-alkyl or N—H,

u represents an integer from 1 to 6,

Ar represents phenyl, thienyl, fluorenyl, pyrrole, carbazole or 1,4-phenylene-vinylene which is optionally substituted by a linear or branched C₁-C₃₀-alkyl or C₁-C₃₀-alkoxy group, F, cyano or CF₃,

R¹²⁵-R¹⁹⁷ are identical or different and, independently of one another, represent H, F CF₃, a linear or branched C₁-C₂₂-alkyl group, a linear or branched C₁-C₂₂-alkoxy group, an optionally C₁-C₃₀-alkyl-substituted C₅-C₂₀-aryl unit and/or an optionally C₁-C₃₀-alkyl-substituted heteroaryl unit having 5 to 9 ring C atoms and 1 to 3 ring heteroatoms from the group consisting of nitrogen, oxygen and sulphur and

Me, X_{L} and n have the meaning mentioned above and recited hereinafter in claim 1.

These are particularly preferably polynuclear metal complexes of the general formula (I), in which

X_{L} is an n-functional linker selected from the following general formulae (XXXI) to (XXXXVI)

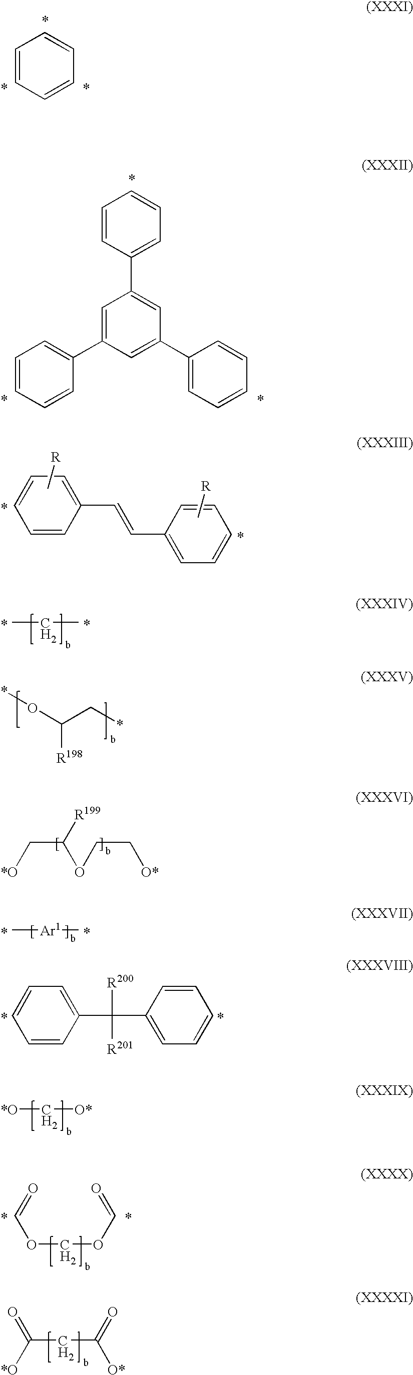

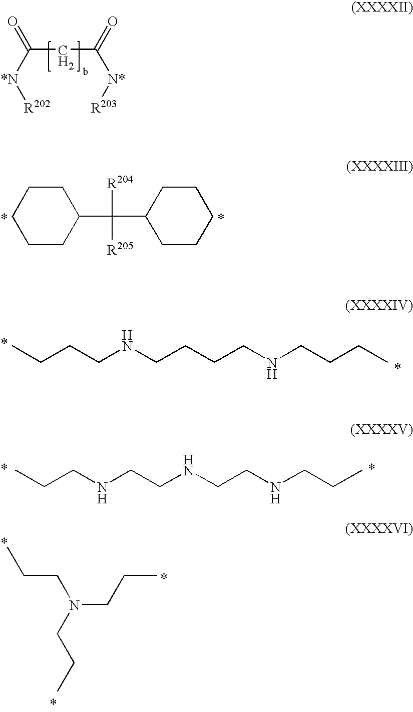

in which

b represents an integer from 2 to 300, preferably from 2 to 100,

R¹⁹⁸-R²⁰⁵ are identical or different and, independently of one another, represent H or linear or branched C₁-C₃₀-alkyl and

Ar¹ represents phenyl, thienyl, fluorenyl, pyrrole, carbazole or 1,4-phenylene-vinylene which is optionally substituted by a linear or branched C₁-C₃₀-alkyl or C₁-C₃₀-alkoxy group, F, cyano or CF₃, or

X_{L} represents α,ω-alkyl, α,ω-oligoethyleneoxy, α,ω-arylene, α,ω-oligoester, α,ω-oligoether, α,ω-dioxyalkyl, α,ω-dioxy-polyester, α,ω-dioxy-oligoester or the corresponding polyacrylate-, polyester- or polyether-polyols (such as Desmophene®, from Bayer AG, Leverkusen), or represents α,ω-linear and branched aliphatic polycarbonate-polyesters,

X_{L} being linked to H_{L} optionally via an ester, ether, amide, amine, imine, carbonate or urethane group.

In the context of the invention, the prefix oligo- in the above mentioned linkers X_{L} represents two to 50 repeating units. The transition from oligo- to poly- is to be considered as fluid so that, in the context of the invention, the prefix poly- in the above mentioned linkers X_{L} represents two or more repeating units.

The linkers X_{L} are bonded to the auxiliary ligands H_{L} via the linkage points marked with *. At these points, it may be necessary to abstract H from the general formulae shown.

Protons on the above mentioned ligands H_{L} can optionally be eliminated for providing the coordination sites necessary for the chelate-like complexing of the metal centres Me. The remaining structures are then likewise denoted by H_{L} in the general formulae of the present application.

The present invention very particularly preferably relates to polynuclear metal complexes selected from the general structures (Ia) to (Ih)

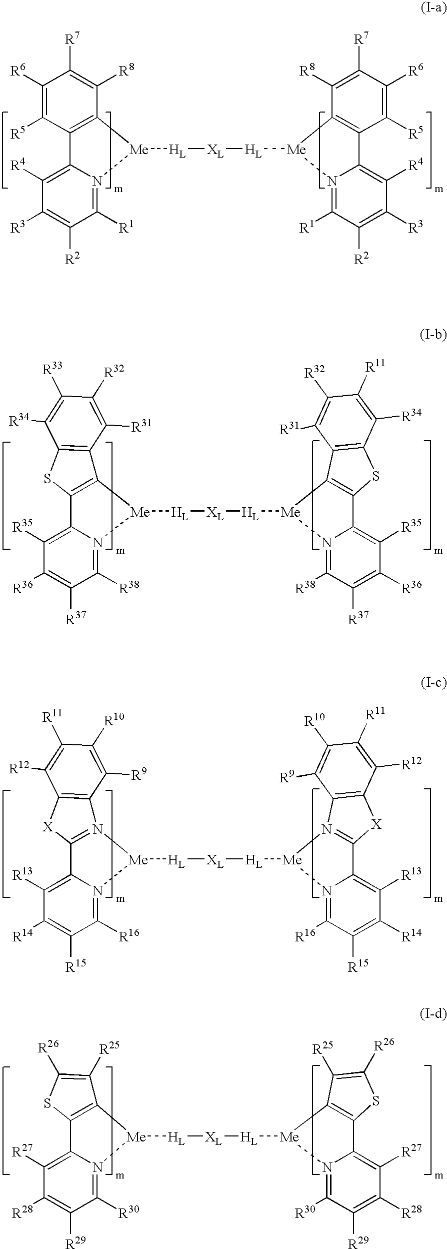

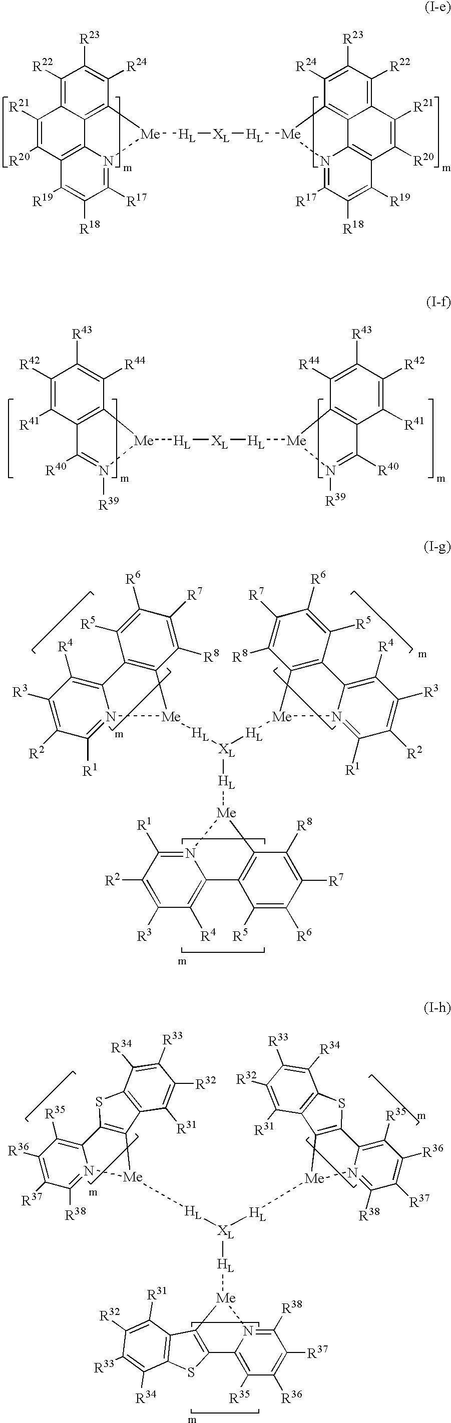

in which

Me represents platinum(II) or iridium(III),

m represents 1 or 2 and

X, R¹-R⁴⁴, H_{L} and X_{L} have the above mentioned meaning.

In preferred embodiments of the present invention, the compounds are as follows:

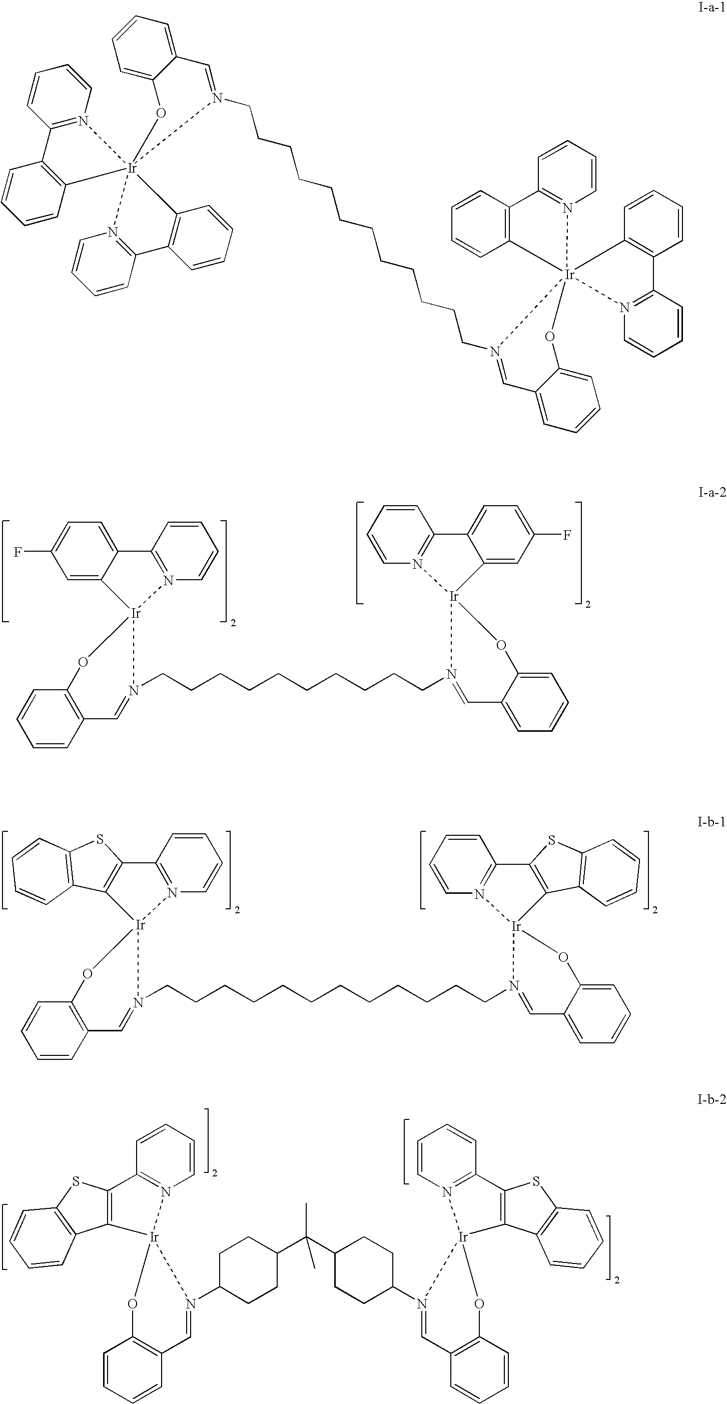

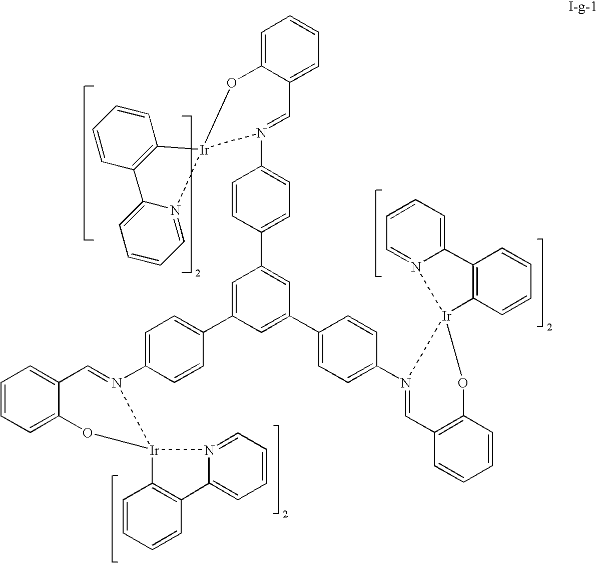

It has surprisingly been found that polynuclear polyphosphorescent metal complexes of the present invention exhibit intensive phosphorescence. The chloro-bridged iridium dimers L₂Ir(μ-Cl)₂IrL₂ known in the literature and thoroughly investigated show virtually no phosphorescence at room temperature (S. Lamansky et al., Inorg. Chem. 2001, 40, 1704). If, however, the two iridium centres are bridged, according to the invention, via a suitable n-functional ligand X_{L}(H_{L})ₙ instead of via chlorine atoms, intense phosphorescence properties are surprisingly found.

The polynuclear metal complexes according to the invention can be prepared in a simple manner from the suitable dinuclear metal complexes known from the literature and of the general formula (A)

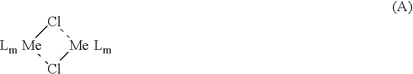

by ligand exchange with an n-functional ligand X_{L}(H_{L})ₙ containing n auxiliary ligands H_{L}, each of which is bidentate.

The present invention furthermore therefore relates to a process for the preparation of the polynuclear metal complexes according to the invention, characterized in that compounds of the general formula (A)

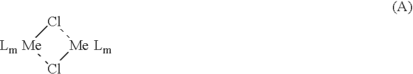

are reacted with an n-functional ligand X_{L}(H_{L})ₙ containing n auxiliary ligands H_{L}, each of which is bidentate, with addition of a base,

m, Me, L, X_{L}, H_{L} and n having the above mentioned meaning.

In the process according to the invention, compounds of the general formula L₂Ir(μ-Cl)₂IrL₂ or LPt(μ-Cl)₂PtL are preferably used as compounds of the formula (A) and Na₂CO₃, K₂CO₃ or sodium methanolate are preferably used as bases. Preferred ligands X_{L}(H_{L})ₙ are all combinations of the general formulae (XX) to (XXX) mentioned above for H_{L} with the general formulae (XXXI) to (XXXXVI) mentioned above for X_{L} or the structures furthermore mentioned for X_{L} and not represented by formulae. Particularly preferred ligands X_{L}(H_{L})ₙ are N,N′-bis-(salicylidene)diamines and N,N′,N′-tris(salicylidene)triamines, very particularly preferably N,N′,N″-tris(salicylidene)aryltriamines or N,N′,N″-tris(salicylidene)alkyltriamines or N,N′-bis(salicylidene)alkyldiamines or N,N′-bis(salicylidene)aryldiamines, it being possible for alkyl to represent, for example, optionally substituted C₁-C₂₀-alkyl, for example decyl, dodecyl, hexadecyl or octadecyl, and optionally to contain ethyleneoxy units or secondary or tertiary amine units, and it being possible for aryl to represent optionally substituted C₁-C₃₀-aryl, for example 2,2-diphenylpropane, 2,2-diphenylmethane, 2,2-dicyclohexylpropane, phenyl, 1,3,5-triphenylbenzene, fluorene or biphenyl.

The reaction is described for mononuclear iridium complexes in WO 01/41512 A1 and can be applied to polynuclear complexes. It can be carried out in customary organic solvents, such as, for example, chlorinated hydrocarbons, alcohols, ethers, aromatics, halogenated aromatics, preferably 1,2-dichloroethane, chloroform, ethanol, methanol, ethoxyethanol, methoxyethanol, glycerol and mixtures of these.

Some of the ligands X_{L}(H_{L})ₙ are commercially available and some can be prepared by customary processes. For example, the N,N′-bis(salicylidene)diamines can be prepared from the corresponding commercially available diamines and salicylaldehyde by boiling in toluene or chloroform using a water separator, optionally with addition of catalytic amounts of toluenesulphonic acid.

It has surprisingly been found that the polynuclear metal complexes according to the invention both have outstanding phosphorescence properties and can be applied from solution. Compared with known mononuclear dopants, they not only have the advantage of better solubility but are also substantially more easily obtainable by the process according to the invention than many of the mononuclear complexes mentioned in the introduction.

Owing to their outstanding phosphorescence properties, the polynuclear metal complexes according to the invention are very suitable as phosphorescence emitters in light-emitting components. The polynuclear metal complexes according to the invention exhibit, on the one hand, electrophosphorescence, i.e. phosphoresce—for example in OLED—through electrical excitation; however, they can also be caused to phosphoresce by optical excitation.

The present invention therefore furthermore relates to the use of the polynuclear metal complexes according to the invention as phosphorescence emitters in light-emitting components, for example organic electroluminescent arrangements, phosphorescent displays, organic light-emitting diodes, laser applications, etc.

Compared with mononuclear metal complexes as emitter materials, the polynuclear metal complexes according to the invention have the advantage in that extinction processes which lead to a decrease in the external quantum efficiency are reduced. In the case of low molecular weight emitters, these occur to a greater extent with increasing metal concentration (local accumulation) as a result of migration processes. In the polynuclear metal complexes according to the invention, the metal centres are on the one hand immobilized to a relatively high degree by linkage via the linkers X_{L} and, on the other hand, are arranged a sufficient distance apart so that they are more stable to migration.

A part of light-emitting components is an electro- or photoluminescent layer arrangement, also referred to as electroluminescent (EL) or photoluminescent arrangement. The polynuclear metal complexes according to the invention are preferably used as phosphorescence emitters in electroluminescent layer arrangements whose basic structure has already been described in the introduction.

The present invention therefore relates to an electroluminescent layer arrangement comprising one or more layers selected from the group consisting of the hole-injecting, hole-conducting, light-emitting, hole-blocking, electron-transporting or electron-injecting layers, characterized in that the light-emitting layer contains the polynuclear metal complexes according to the invention as phosphorescence emitters. Furthermore, the electroluminescent layer arrangement may contain two or more electrodes, at least one of which is advantageously transparent, a support or a substrate on which one of the electrodes is applied and which is likewise advantageously transparent, two contacts and a covering for encapsulation. For simplification of the layer structure, one layer may also form a plurality of functions so that layers in the above mentioned list can be omitted.

The light-emitting layer may contain the polynuclear metal complexes according to the invention as layer-forming materials without additives or as dopants embedded in a matrix.

The present invention preferably relates to an electroluminescent layer arrangement, in which the polynuclear metal complexes according to the invention are embedded as dopants in a low molecular weight or polymeric matrix. This also includes those matrices which are composed of mixtures of polymeric and low molecular weight components.

The matrix may contain 0.1 to 30 percent by weight, preferably 1 to 10 percent by weight, of the polynuclear metal complexes according to the invention. Where it is polymeric, the matrix can preferably be based on poly-N-vinylcarbazoles (PVK), poly-2,7-fluorenes (PF), poly-para-phenylenes (PPP) or a mixture of at least one of these polymers and 2-(4-biphenylyl)-5-(4-tert-butylphenyl)-1,3,4-oxadiazole (PBD). Where it has a low molecular weight, the matrix can preferably be composed of 4,4′-N,N′-dicarbazaolebiphenyl (CBP) or of a hole-conducting material described below and based on aromatic tertiary amines. It may also be composed of a mixture of these compounds with 2-(4-biphenylyl)-5-(4-tert-butylphenyl)-1,3,4-oxadiazole (PBD).

All electroluminescent layer arrangements which are described above and whose light-emitting layer contains the polynuclear metal complexes according to the invention as phosphorescence emitters are referred to below as electroluminescent layer arrangements according to the invention and are described as preferred embodiments.

In a preferred embodiment, the electroluminescent layer arrangement according to the invention contains a hole-blocking layer which consists of 2,9-dimethyl-4,7-diphenyl[1,10]phenanthroline (BCP, bathocuproin), bis(2-methyl-8-hydroxyquinolinato)gallium chloride (Ga(qa)₂Cl), Ga(qa)₂F, Ga(qa)₂—O—Ga(qa)₂ or 3-(4-biphenylyl)₄-phenyl-5-tert-butyl-phenyl-1,2,4-triazole (TAZ).

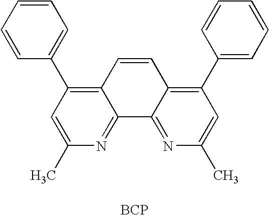

BCP and TAZ are commercially available. Ga(qa)₂Cl, Ga(qa)₂F and Ga(qa)₂—O—Ga(qa)₂ are described in Elschner et al., Adv. Mater. 2001, 13, 1811-1814.

In a further preferred embodiment, the electroluminescent arrangement according to the invention contains a hole-injecting layer which contains a cationic polythiophene of the general formula (B)

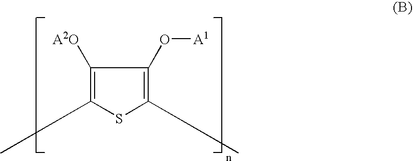

in which

A¹ and A², independently of one another, represent optionally substituted (C₁-C₁₈)-alkyl or together form optionally substituted (C₁-C₁₈)-alkylene and

n represents an integer from 2 to 10 000, preferably 3 to 5 000.

“Cationic” polythiophene refers only to the charges which are present on the polythiophene main chain. Those charges which are optionally present on the substituents A¹ or A² are not taken into account.

Particularly preferred cationic polythiophenes are composed of structural units of the formula (Ba) or (Bb)

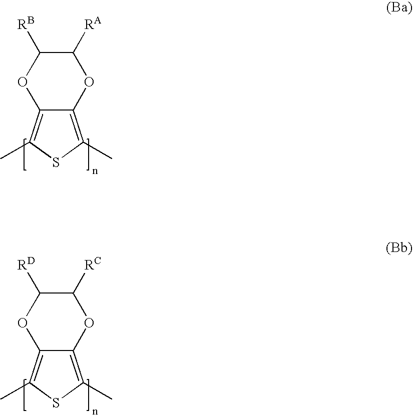

in which

R^{A} and R^{B}, independently of one another, represent hydrogen, optionally substituted (C₁-C₁₈)-alkyl, preferably (C₁-C₁₀)-alkyl, in particular (C₁-C₆-alkyl), optionally substituted (C₂-C₁₂)-alkenyl, preferably (C₂-C₈)-alkenyl, optionally substituted (C₃-C₇)-cycloalkyl, preferably cyclopentyl, cyclohexyl, optionally substituted (C₇-C₁₅)aralkyl, preferably phenyl-(C₁-C₄)-alkyl, optionally substituted (C₆-C₁₀)-aryl, preferably phenyl, naphthyl, optionally substituted (C₁-C₁₈)-alkoxy, preferably (C₁-C₁₀)-alkoxy, for example methoxy, ethoxy, n-propoxy or isopropoxy, or optionally substituted (C₂-C₁₈)-alkoxy ester and

R^{C} and R^{D}, independently of one another, represent hydrogen, but not both simultaneously, (C₁-C₁₈)-alkyl, preferably (C₁-C₁₀)-alkyl, in particular (C₁-C₆)-alkyl, substituted by at least one sulphonate group, (C₂-C₁₂)-alkenyl, preferably (C₂-C₈)-alkenyl, substituted by at least one sulphonate group, (C₃-C₇)-cycloalkyl, preferably cyclopentyl or cyclohexyl, substituted by at least one sulphonate group, (C₇-C₁₅)-aralkyl, preferably phenyl-(C₁-C₄)-alkyl, substituted by at least one sulphonate group, (C₆-C₁₀)-aryl, preferably phenyl or naphthyl, substituted by at least one sulphonate group, (C₁-C₁₈)-alkoxy, preferably (C₁-C₁₀)-alkoxy, for example methoxy, ethoxy, n-propoxy or isopropoxy, substituted by at least one sulphonate group or (C2-C₁₈)-alkoxy ester substituted by at least one sulphonate group and

n represents a number from 2 to 10 000, preferably 3 to 5 000.

Particularly preferably, R^{C} and R^{D}, independently of one another, represent hydrogen, but not both simultaneously, or one of the above mentioned radicals, the radical being substituted by a sulphonate group.

Cationic or neutral polyalkylenethiophenes of the formulae (Ba-1) and (Bb-1)

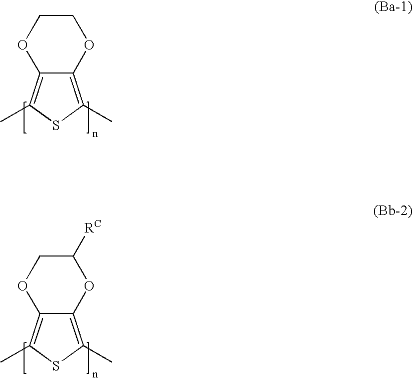

in which

R^{C} represents (C₁-C₁₈)-alkyl, preferably (C₁-C₁₀)-alkyl, in particular (C₁-C₆)-alkyl, substituted by at least one sulphonate group, (C₂-C₁₂)-alkenyl, preferably (C₂-C₈)-alkenyl, substituted by at least one sulphonate group, (C₃-C₇)-cycloalkyl, preferably cyclopentyl or cyclohexyl, substituted by at least one sulphonate group, (C₇-C₁₅)-aralkyl, preferably phenyl-(C₁-C₄)-alkyl, substituted by at least one sulphonate group, (C₆-C₁₀)-aryl, preferably phenyl or naphthyl, substituted by at least one sulphonate group, (C₁-C₁₈)-alkoxy, preferably (C₁-C₁₀)-alkoxy, for example methoxy, ethoxy, n-propoxy or isopropoxy, substituted by at least one sulphonate group or (C₂-C₁₈)-alkoxy ester substituted by at least one sulphonate group and

n represents an integer from 2 to 10 000, preferably from 3 to 5 000.

Particularly preferably, R^{C} represents one of the above mentioned radicals, the radical being substituted by a sulphonate group.

In a further preferred embodiment of the invention, n in said formulae represents an integer from 4 to 15.

Polyanions which are, for example, anions of polymeric carboxylic acids, such as polyacrylic acids, polymethacrylic acids, polymaleic acid and polymeric sulphonic acids, such as polystyrenesulphonic acids and polyvinylsulphonic acids, serve as opposite ions for the cationic polythiophenes. These polycarboxylic and polysulphonic acids may also be copolymers of vinylcarboxylic and vinylsulphonic acids with other polymerizable monomers, such as acrylic esters and styrene.

The anion of polystyrenesulphonic acid (PSS) is particularly preferred as an opposite ion.

The molecular weight of the polyacids donating the polyanions is preferably 1 000 to 2 000 000, particularly preferably 2 000 to 500 000. The polyacids or their alkali metal salts are commercially available, e.g. polystyrenesulphonic acids and polyacrylic acids, or can be prepared by known processes (cf. e.g. Houben Weyl, Methoden der organischen Chemie [Methods of Organic Chemistry], Vol. E 20 Makromolekulare Stoffe [Macromolecular Substances], Part 2, (1987), page 1141 et seq.).

Instead of the free polyacids required for the formation of the dispersions of polyalkylenedioxythiophenes and polyanions, mixtures of alkali metal salts of the polyacids and corresponding amounts of monoacids may also be used.

In the case of the formula (Bb-1), the polyalkylenedioxythiophenes carry positive and negative charges in the structural unit, the positive charges being present on the polythiophene main chain and the negative charges on the radicals R^{C} substituted by sulphonate groups. The positive charges of the polythiophene main chain are partly or completely saturated by the anionic groups on the radical R^{C}.

The preparation of the polyalkylenedioxythiophenes is described, for example, in EP-A 0 440 957 (U.S. Pat. No. 5,300,575). The polyalkylenedioxythiophenes are prepared by oxidative polymerization. They thus acquire positive charges which are not shown in the formulae since their number and their position cannot be satisfactorily determined.

The polythiophene dispersion can be applied to the transparent conductive substrate by established economical methods, such as casting, printing, spraying, dipping, flooding or inkjet. Here too, no expensive vacuum process is required.

In a further preferred embodiment, the electroluminescent layer arrangement according to the invention contains a hole-conducting layer which contains an aromatic amine of the formula (C)

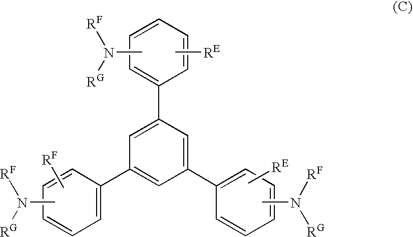

in which

R^{E} represents hydrogen, optionally substituted alkyl or halogen and

R^{F} and R^{G}, independently of one another, represent optionally substituted (C₁-C₁₀)-alkyl, alkoxycarbonyl-substituted (C₁-C₁₀)-alkyl, or aryl, aralkyl or cycloalkyl, each of which is optionally substituted.

R^{F} and R^{G}, independently of one another, preferably represent (C₁-C₆)-alkyl, in particular methyl, ethyl, n-propyl or isopropyl, n-butyl, isobutyl, sec-butyl or tert-butyl, (C₁-C₄)-alkoxycarbonyl-(C₁-C₆)-alkyl, such as, for example, methoxy-, ethoxy-, propoxy- or butoxycarbonyl-(C₁-C₄)-alkyl, or phenyl-(C₁-C₄)-alkyl, naphthyl-(C₁-C₄)-alkyl, cyclopentyl, cyclohexyl, phenyl or naphthyl, each of which is optionally substituted by (C₁-C₄)-alkyl and/or by (C₁-C₄)-alkoxy.

Particularly preferably, R^{F} and R^{G}, independently of one another, represent unsubstituted phenyl or naphthyl or phenyl or naphthyl each of which is monosubstituted or trisubstituted by methyl, ethyl, n-propyl, isopropyl, methoxy, ethoxy, n-propoxy and/or isopropoxy.

R^{E} preferably represents hydrogen, (C₁-C₆)-alkyl, such as, for example, methyl, ethyl, n-propyl, isopropyl, n-butyl, isobutyl, sec-butyl or tert-butyl, or chlorine.

Such compounds and their preparation are described in U.S. Pat. No. 4,923,774 for use in electrophotography. The tris-nitrophenyl compound can be converted into the tris-aminophenyl compound, for example by generally known catalytic hydrogenation, for example in the presence of Raney nickel (Houben-Weyl 4/1C, 14-102, Ullmann (4) 13, 135-148). The amino compound is reacted in a generally known manner with substituted halogenobenzenes.

The following compounds of the general formula (C) may be mentioned by way of example:

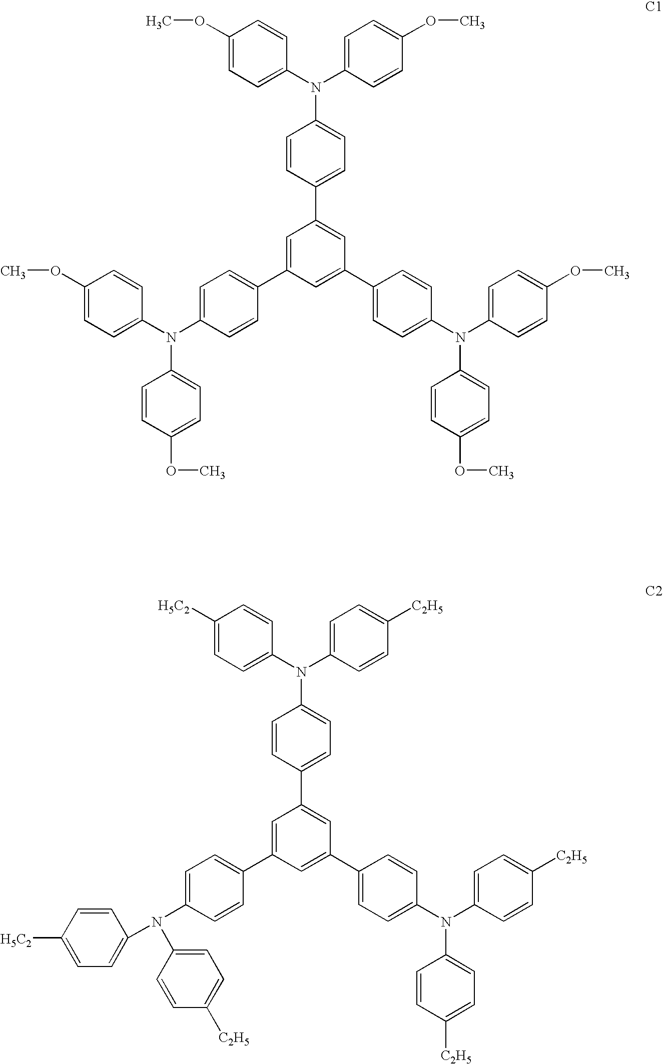

In addition to the tertiary amino compound, further hole conductors, for example in the form of a mixture with the tertiary amino compound, can optionally be used for producing the electroluminescent element. These may be, on the one hand, one or more compounds of the formula (VI), mixtures of isomers also being included, and, on the other hand, also mixtures of hole-transporting compounds with tertiary amino compounds—of the general formula (VI)—having a different structure.

A list of possible hole-conducting materials is given in EP-A 0 532 798.

In the case of mixtures of the aromatic amines, the compounds can be used in any desired ratio.

The compounds described above and having hole-conducting or hole-transporting properties may also serve, as already described elsewhere in this application, as a low molecular weight matrix for embedding the polynuclear metal complexes according to the invention in the light-emitting layer.

The layer arrangement according to the invention preferably additionally contains an electron transport layer. A multiplicity of compounds which are suitable for use in such a layer is already known.

Thus, for example, Alq₃ is used according to WO 00/70 655 A2. This compound is a pigment which, owing to its insolubility in customary solvents, can be applied exclusively by a vapour deposition process.

A gallium complex from the group consisting of Ga(qa)₂OR^{H}, Ga(qa)₂OCOR^{H}, Ga(qa)₂Cl, Ga(qa)₂F or Ga(qa)₂—O—Ga(qa)₂ is therefore preferably used for the production of the electron transport layer (described in Elschner et al., Adv. Mater. 2001, 13, 1811-1814 or the still unpublished German Patent Application DE-A 10 225 826).

In a further preferred embodiment, the electron-transporting layer of the electroluminescent layer arrangement according to the invention contains a gallium complex from the group consisting of Ga(qa)₂—OR^{H}, Ga(qa)₂—OCOR^{H} or Ga(qa)₂—O—Ga(qa)₂,

R^{H} representing substituted or unsubstituted alkyl, alkenyl, aryl, arylalkyl or cycloalkyl and (qa) representing

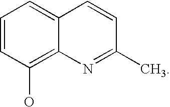

In contrast to Alq₃, these gallium compounds can be processed both from solution and by means of vapour deposition methods. Suitable solvents are, for example, methanol, ethanol, n-propanol or isopropanol.

R^{H} preferably represents halogen- or cyano-substituted or unsubstituted, optionally branched alkyl or alkenyl, in particular represents halogen- or cyano-substituted or unsubstituted, optionally branched (C₁-C₈)-alkyl or (C₁-C₈)-alkenyl, particularly preferably represents halogen- or cyano-substituted or unsubstituted, optionally branched (C₁-C₆)-alkyl or (C₁-C₆)-alkenyl. Fluorine and chlorine are preferred as halogen.

For example, gallium compounds of the formulae (D1) to (D4) are used.

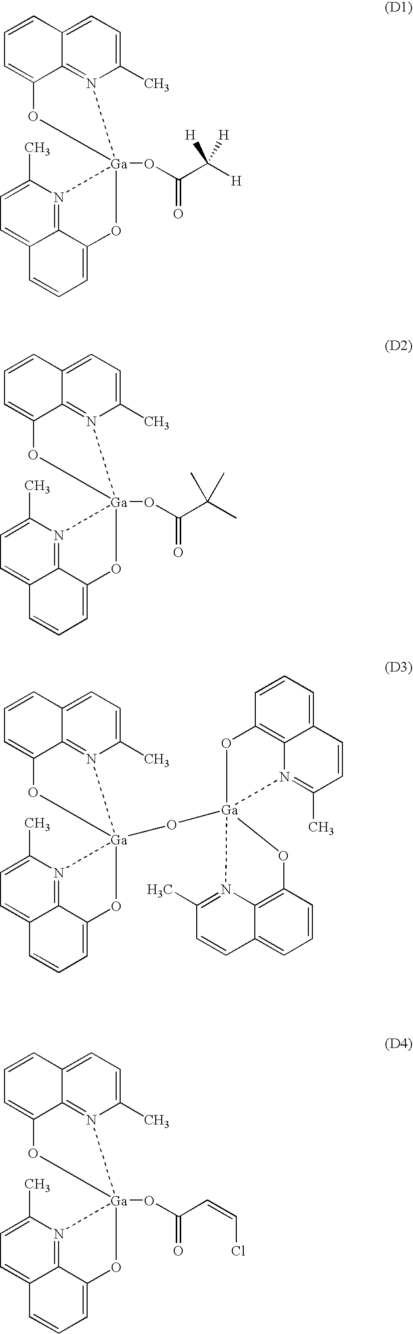

Glass, very thin glass (flexible glass) and plastics are suitable as a transparent substrate which is provided with a conductive layer (electrode).

Particularly suitable plastics are: polycarbonates, polyesters, copolycarbonates, polysulphone, polyethersulphone, polyimide, polyethylene, polypropylene or cyclic olefins or cyclic olefin copolymers (COC), hydrogenated styrene polymers or hydrogenated styrene copolymers.

Preferred polymers are polycarbonates, polyesters, polysulphone, polyethersulphone, cyclic olefin copolymers, hydrogenated styrene polymers and hydrogenated styrene copolymers. From the group consisting of the polyesters, PET and PEN (polyethylene terephthalate and polyethylene naphthenate, respectively) are preferred.

Suitable polymer substrates are, for example, polyester films, PES films from Sumitomo or polycarbonate films from Bayer AG (Makrofol®).

These substrates can be rendered scratch-resistant and/or resistant to chemicals by means of an additional layer.(e.g. Manot® films (Bayer AG).

From the group consisting of the polycarbonates, the poly- or copolycarbonates which contain one of the following segments are particularly suitable:

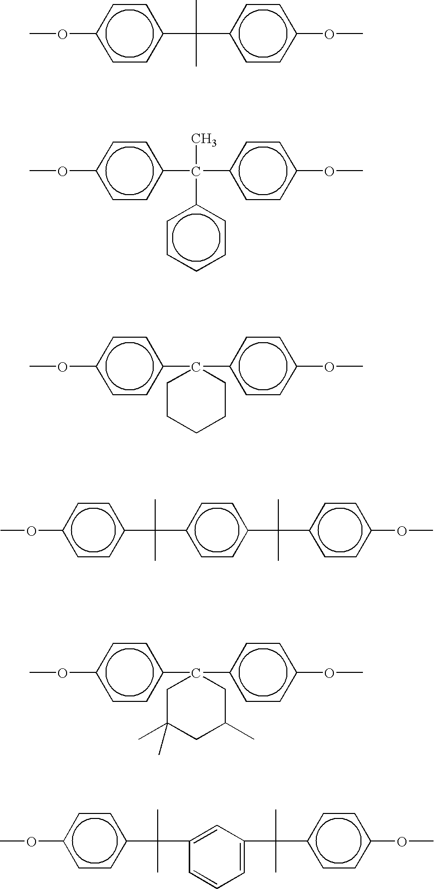

Further bisphenols for the synthesis of polycarbonates are described, for example, in EP-A 359 953.

In a further preferred embodiment, the electroluminescent layer arrangement according to the invention is encapsulated.

Further preferred embodiments of the electroluminescent layer arrangement according to the invention are all combinations of preferred embodiments described above.

The electroluminescent layer arrangement according to the invention is suitable in particular as a part of light-emitting components, such as, for example, organic electroluminescent arrangements, phosphorescent displays, organic light-emitting diodes, laser applications, lighting elements, large-area radiation sources, etc. Accordingly, the invention also relates to light-emitting components which contain an electroluminescent layer arrangement according to the invention.

The layer arrangement according to the invention can be produced, for example, as follows: an organic electrically conductive polythiophene according to the general formula (B) is applied in the form of a solution or dispersion to a substrate coated with an electrically conductive indium tin oxide layer (ITO layer). A following heating process serves for removing the solvent fractions. The preferably used amines of the formula (C) are then likewise applied in the form of a wet coating step to the layer of the organic conductive polymer system. Here too, a heating step is effected for removing the solvent. A subsequent light-emitting layer, containing the polynuclear phosphorescence emitters according to the invention, is likewise applied from solution by a wet coating step.

A hole-blocking layer is then optionally applied by vapour deposition. A subsequent electron transport layer comprising a gallium complex compound is now applied to the light-emitting layer or the hole-blocking layer, once again preferably from a solution, for example in methanol.

For the production of an electroluminescent arrangement, for example, a metal substrate which serves as a cathode can then be applied, optionally once again by vapour deposition. The ITO layer acts as the anode.

The advantage of the layer structure according to the invention thus also consists in substantial reduction of the required high-vacuum coating steps in the production of all organic functional layers.

The invention therefore also relates to a process for the production of the electroluminescent layer arrangements according to the invention, characterized in that the light-emitting layer containing the polynuclear metal complexes according to the invention is applied from solution.

Where the polynuclear metal complexes according to the invention in the light-emitting layer of the electroluminescent layer arrangements according to the invention are to be embedded in a low molecular weight or polymeric matrix. This is a process characterized in that the polynuclear metal complexes according to the invention are applied together with the matrix from solution.

The polynuclear metal complexes according to the invention are contained in the solution in an amount of 0.01 to 5 percent by weight, particularly preferably 0.1 to 2 percent by weight. Preferred solvents are toluene, chloroform, chlorobenzene, trichlorobenzene, xylenes, etc.

### EXAMPLES

All starting materials used are either commercially available or can be prepared by known and customary processes.

The abbreviations used below for various ligands have the following meaning:

| | |
|---|---|
| ppy: | Phenyl-2-pyridine |
| bthpy: | 2-Benzo[b]thiophen-2-yl-pyridine |
| F-ppy: | 4-Fluorophenyl-2-pyridine |

### Example 1

Exemplary Synthesis of the Ir Complex L₂Ir(μ-Cl)₂IrL₂ (Where L=2-phenylpyridine)

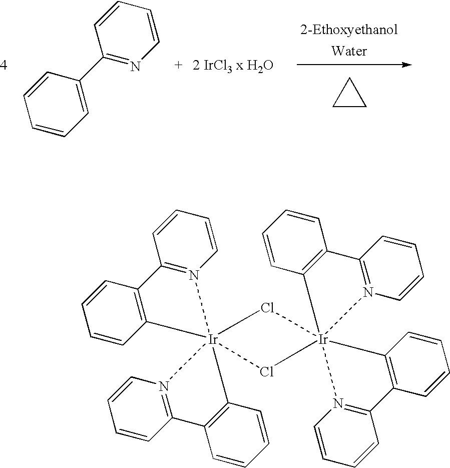

A mixture of 1.0 g (2.84 mmol) of iridium(III) trichloride hydrate and 0.88 g (5.67 mmol) of 2-phenylpyridine in 100 ml of freshly distilled 2-ethoxyethanol and 33 ml of distilled water is degassed several times by means of an oil pump and in each case nitrogen is passed in. The reaction batch is refluxed for 13 hours under nitrogen. Thereafter, the precipitated solid is filtered off with suction and rinsed with ethanol. After drying in a vacuum drying oven at 50° C., a yellow solid is obtained.

Yield: 0.97 g (63.8% of the theoretical yield)

Characterization: ¹H-NMR (400 MHz, d6-DMSO, 25° C., TMS)

All further iridium complexes L₂Ir(μ-Cl)₂IrL₂ used below can be prepared by the same synthesis method.

### Example 2-a

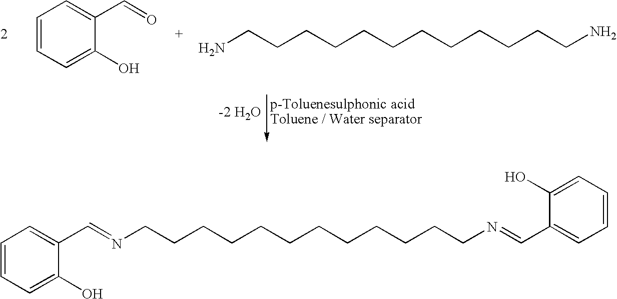

0.5 g of p-toluenesulphonic acid as a catalyst is added to 61.06 g (0.5 mol) of 2-hydroxybenzaldehyde and 50.09 g (0.25 mol) of 1,12-diaminododecane in 500 ml of dried toluene (over 4 Å molecular sieve) and reacted to give Schiff's base with elimination of water. After washing neutral and salt-free has been effected, the crude product obtained is recrystallized altogether twice more in toluene. After drying at 55° C. (blow dryer, high vacuum), a neon-yellow, pulverulent solid is obtained.

Yield: 9.04 g (8.8% of the theoretical yield)

Characterization: ¹H-NMR (400 MHz, CDCl₃, 25° C., TMS) δ=1.31 (16H, CH₂), 1.64 (4H, CH₂—CH₂—N═), 3.55 (4H, CH₂—N═), 7.28-6.85 (8H, arom.), 8.30 (2H, —CH₂═N), 13.7 (2H, OH).

### Example 2-b

The analogous reaction of 2-hydroxybenzaldehyde with diaminodecane is effected as described in Example 2-a.

### Example 2-c

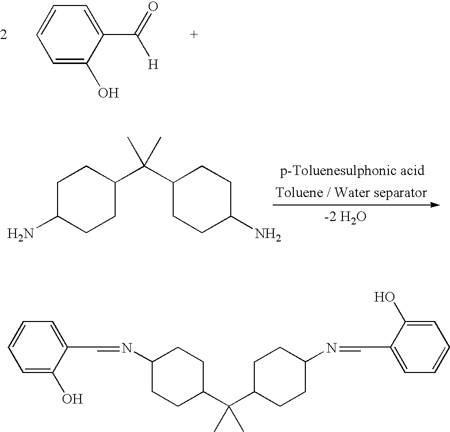

9.77 g (80 mmol) of 2-hydroxybenzaldehyde were reacted in an analogous manner with 9.54 g (40 μmmol) of the cyclohexylamine compound.

For purification, the crude product is dissolved in methylene chloride and precipitated in 40/60 petroleum ether. The product is filtered off with suction and dried in a vacuum drying oven. A yellow powder is obtained.

M.p. 179° C.

Characterization: ¹H-NMR (400 MHz, CDCl₃): δ=0.78 (6H, CH₃), 6.83 to 7.30 (16H, protons on the aromatic), 8.16 (2H, ═CH), 13.7 (2H OH).

Yield: 4.3 g (=25% of theory)

### Example 2-d

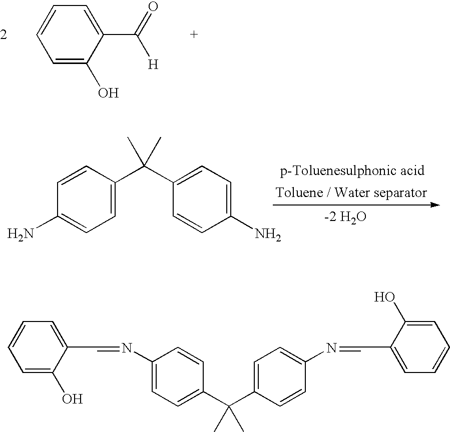

9.77 g (80 mmol) of 2-hydroxybenzaldehyde were reacted in an analogous manner with 9.05 g (40 mmol) of the aniline compound.

For purification, the crude product is dissolved in methylene chloride and precipitated in 40/60 petroleum ether. The product is filtered off with suction and dried in a vacuum drying oven. A yellow powder is obtained.

M.p. 174° C.

Characterization: ¹H-NMR (400 MHz, CDCl₃): δ=1.69 (6H, CH₃), 6.92 to 7.48 (16H, protons on the aromatic), 8.61 (2H, ═CH), 13.3 (2H OH).

Yield: 14.6 g (=84% of theory)

### Example 2-e

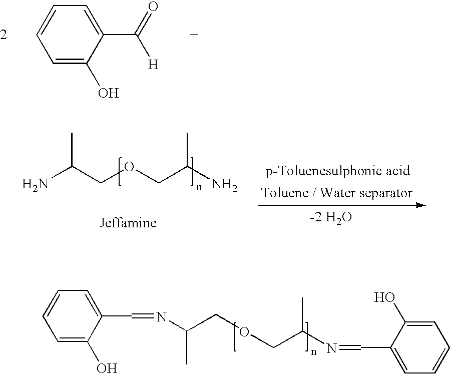

32.24 g (0.264 mol) of 2-hydroxybenzaldehyde and 239.59 g (0.12 mol) of Jeffamine® D-2000 (n=33.1, Huntsman) are reacted in the molar ratio 2.2:1 in 250 ml of dried toluene (over 4 Å molecular sieve). 0.5 g of p-toluenesulphonic acid is added to the reaction as a catalyst.

On heating under reflux, the resulting water of reaction is removed using a water separator. The crude product obtained is washed neutral and electrolyte-free with distilled water and purified by means of column chromatography (toluene eluent).

After working-up, an orange, clear liquid of medium viscosity is obtained.

### Example 2-f

The analogous reaction of 0.12 mol of Jeffamine® D-230 (n=2.6, Huntsman) with 2-hydroxybenzaldehyde is effected as described in example 2-e.

### Example 2-g

The analogous reaction of 0.12 mol of Jeffamin® D-400 (n=5.6, Huntsman) with 2-hydroxybenzaldehyde is effected as described in example 2-e.

### Example 2-h

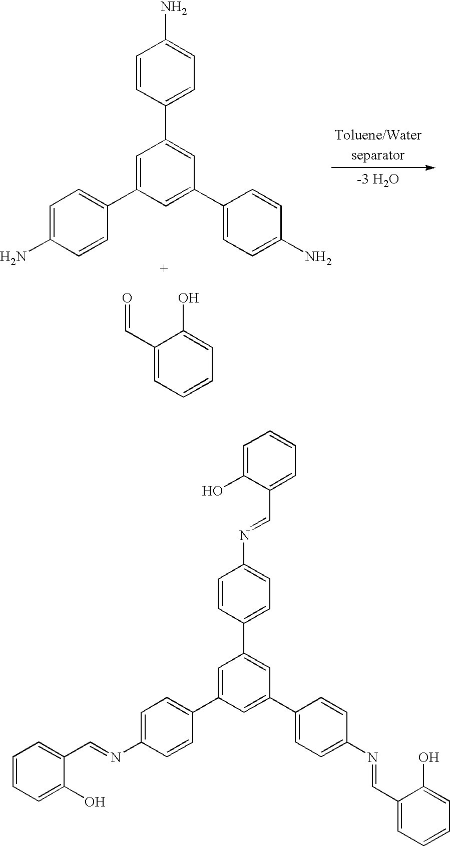

4.0 g (11.4 mmol) of 1,3,5-tris(4-aminophenyl)benzene is boiled with 1.4 g (11.4 mmol) of salicylaldehyde in 100 ml of toluene for 12 h using a water separator. The clear red-brown solution is evaporated down to 10 ml and the crude product crystallizes out at 4° C. For purification, recrystallization is effected from ethanol (100 ml)/toluene (25 ml), followed by chromatography over silica gel (CH₂Cl₂/methanol 99:1), and the product is finally recrystallized again from ethanol/toluene. After drying, a yellow solid which phosphoresces yellow under a UV lamp (366 nm) is obtained.

Yield: 1.2 g (16% of theory)

M.p. 191° C.

¹H-NMR (400 MHz, CDCl₃, TMS) δ=8.73 (s; 3H; N═CH—); 7.84 (s; 3H; H2, H4, H6); 7.79 (d; 6H), 7.46-7.38 (m; 12H), 7.06 (d; 3H; Hₛₐₗ), 6.98 (t; 3H; Hₛₐₗ).

### Example 2-i

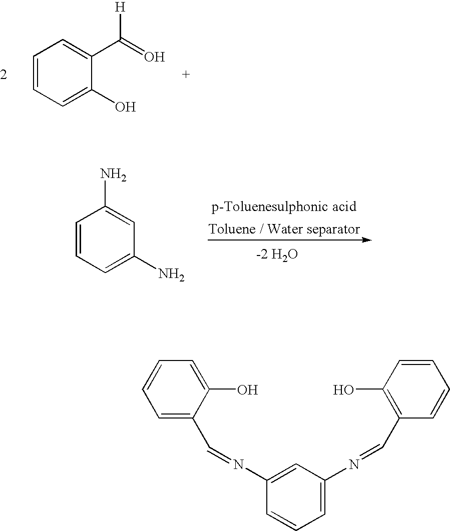

61.06 g (0.50 mol) of 2-hydroxybenzaldehyde and 27.04 g (0.25 mol) of m-phenylenediamine are reacted in the molar ratio 2:1 in 500 ml of dried toluene (over 4 Å molecular sieve). 0.5 g of p-toluenesulphonic acid is added to the reaction as a catalyst. On heating under reflux, the resulting water of reaction is removed using a water separator. The crude product obtained is washed neutral and electrolyte-free with distilled water and dried in a vacuum drying oven at 90° C. After drying, yellow-orange crystals are obtained.

Yield: 68.9 g (87.1% of the theoretical yield).

Purification: 10 g of crude product are recrystallized in 50 ml of toluene and dried at 70° C. in a vacuum drying oven. After drying, a fluorescent yellow-orange solid is obtained.

Yield: 5.0 g (50% of the theoretical yield)

M.p.: 108° C.

Characterization: ¹H-NMR (400 MHz, CDCl₃): 13.09 (2H, OH); 8.64 (2H, N═CH); 7.46 to 6.93 (12H, arom. protons).

### Example 2-j

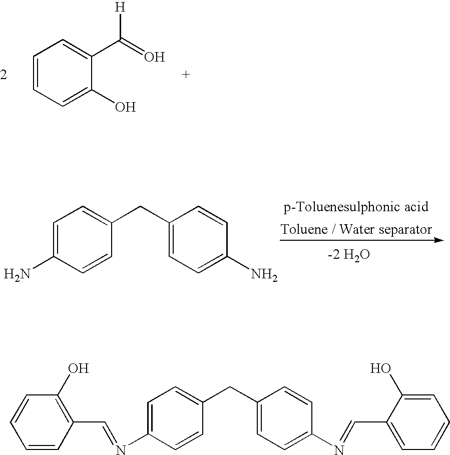

61.06 g (0.50 mol) of 2-hydroxybenzaldehyde and 49.57 g (0.25 mol) of 4,4-diaminodiphenylmethane are reacted in the molar ratio 2:1 in 700 ml of dried toluene (over 4 Å molecular sieve). 0.5 g of p-toluenesulphonic acid is added to the reaction as a catalyst. On heating under reflux, the resulting water of reaction is removed using a water separator. The crude product obtained is washed neutral and electrolyte-free with distilled water and dried in a vacuum drying oven at 90° C. After drying, a fluorescent yellow solid is obtained.

Yield: 93.8 g (92.3% of the theoretical yield).

Purification: 10 g of crude product are recrystallized in 200 ml of chlorobenzene and dried at 70° C. in a vacuum drying oven. After drying, a fluorescent yellow solid is obtained.

Yield: 9.2 g (92% of the theoretical yield)

M.p.: 216° C.

Characterization: ¹H-NMR (400 MHz, d6-DMSO): 13.16 (2H, OH); 8.94 (2H, N═CH—); 7.64 to 6.95 (16H, arom. protons): 4.03 (2H, aromat-CH₂-aromat).

### Example 2-k

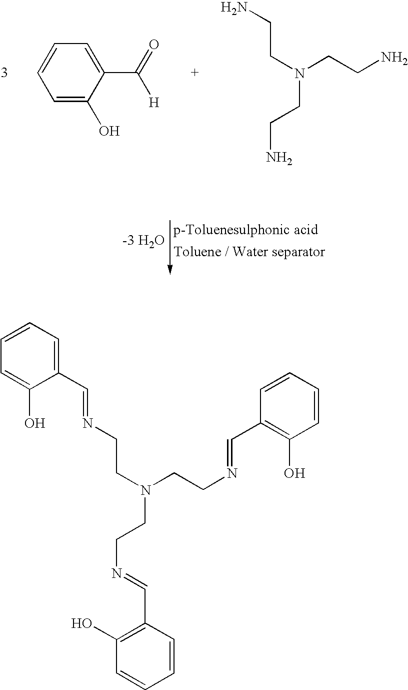

Reaction analogous to example 2-j. Recrystallization of the crude product from cyclohexanone/petroleum ether 40-60 in the ratio of 1:10.

¹H-NMR (CDCl₃, 400 MHz): 13.78 (3H, OH), 7.80 (3H, CH═), 7.29-6.07 (12H, arom.), 3.57 and 2.82 (6H each, CH₂—N═ and N—CH₂).

M.p. 93° C.

### Example 3-a

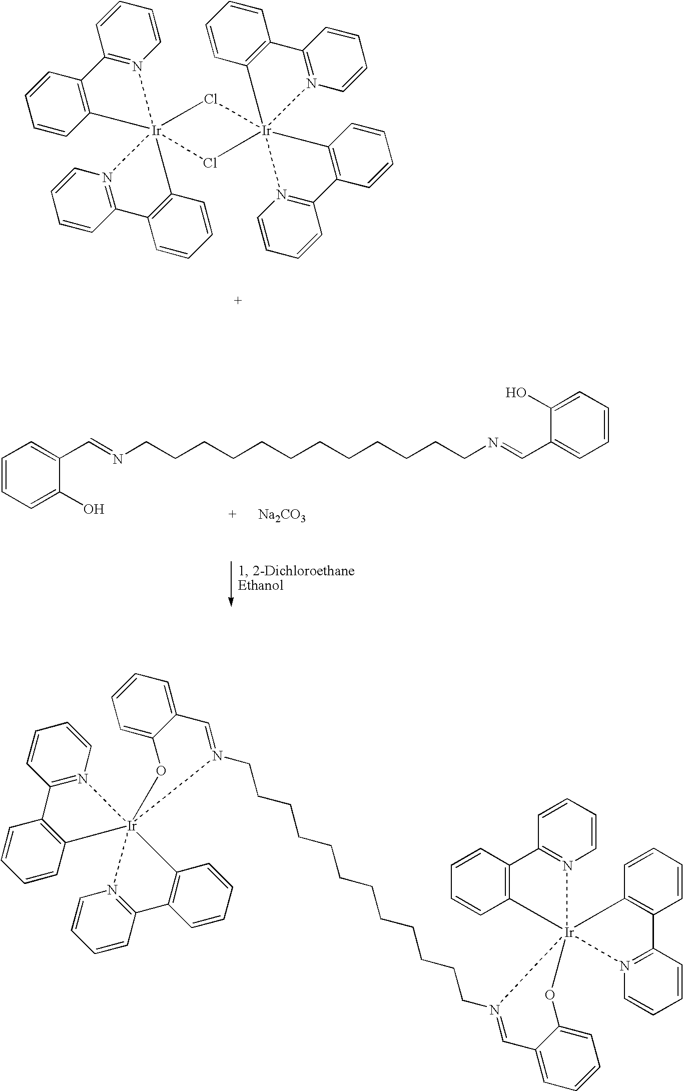

2.0 g (1.864 mmol) of the iridium complex compound from Example 1 are refluxed together with 0.762 g (1.864 mmol) of the Schiff's base from Example 2-a and 0.212 g (2 mmol) of sodium carbonate in a mixture of 280 ml of 1,2-dichloroethane and 56 ml of ethanol under nitrogen for 3 hours and 20 minutes. The resulting precipitate is separated off and is washed neutral with water. The crude product is purified by means of flash chromatography. After drying, an orange solid which has an orange-red emission under a UV lamp is obtained.

Yield: 0.2 g (7.6% of the theoretical yield)

Characterization: ¹H-NMR (400 MHz, CDCl₃, 25° C., TMS)

MALDI-TOF: C₇₀H₆₆N₆O₂Ir₂: calc.: 1407.8, found: 1407.

### Example 3-b

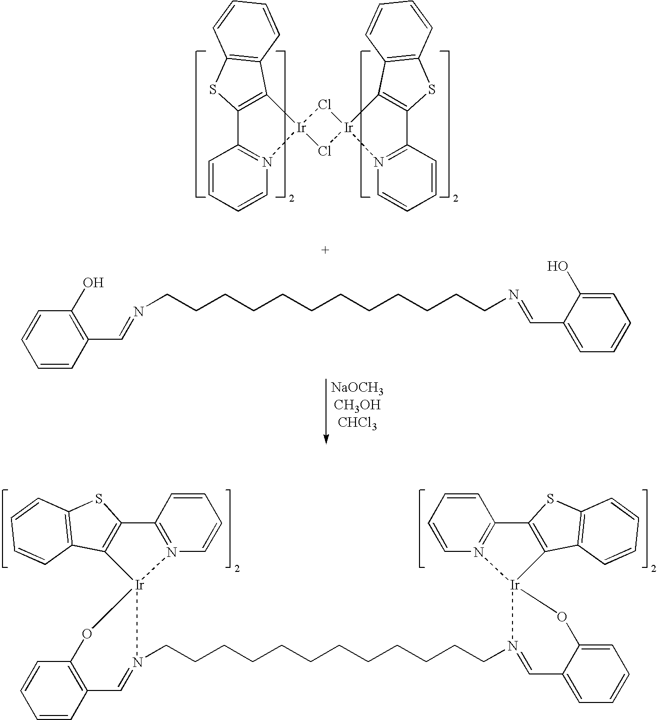

Under a countercurrent stream of nitrogen, 18 mg (0.333 mmol) of sodium methanolate in 2 ml of methanol are initially introduced into a carefully heated flask. 67 mg (0.164 mmol) of Schiff's base from example 2-a in 5 ml of chloroform and then 200 mg (0.155 mmol) of iridium complex ((bthpy)₂Ir(μ-Cl)₂Ir(bthpy)₂) in 20 ml of chloroform are added while stirring. The solution is degassed four times by applying a vacuum and subsequently passing in nitrogen and is then refluxed for 14 hours. After cooling, filtration is effected, the residue is boiled with 25 ml of chloroform and filtered, and the filtrates are combined. The solvent is stripped off in a rotary evaporator and the residue is taken up in toluene and precipitated with n-hexane. The product is further purified by chromatography over silica gel (CH₂Cl₂). An orange-red solid which phosphoresces red under a UV lamp is obtained. Solutions (e.g. in chloroform) likewise have intense red phosphorescence under a UV lamp.

Yield: 94.5 mg (35% of theory)

Melting point: 232° C. (decomposition)

Characterization: ¹H-NMR (400 MHz, CDCl₃, TMS).

MALDI-TOF (matrix): C₇₈H₆₆N₆O₂S₄Ir₂: M⁺ calc. 1632.1; found 1631.9.

### Example 3-c

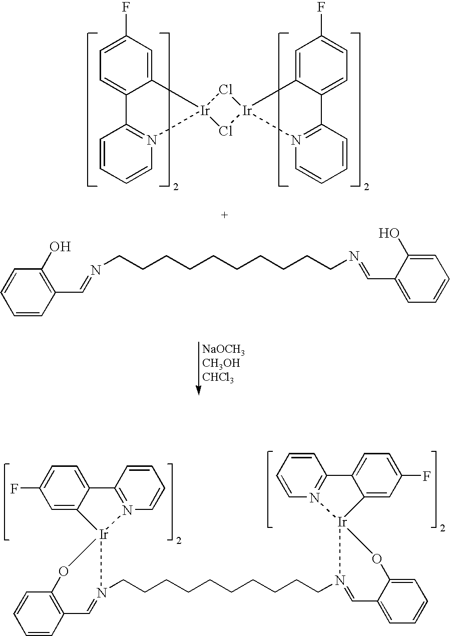

Under a countercurrent stream of nitrogen, 19 mg (0.35 mmol) of sodium methanolate in 2 ml of methanol are initially introduced into a carefully heated flask. 57 mg (0.15 mmol) of Schiff's base from example 2-b and 200 mg (0.176 mmol) of iridium complex ((F-ppy)₂Ir(μ-Cl)₂Ir(F-ppy)₂ in 25 ml of chloroform are added while stirring. The solution is degassed 3 times by applying a vacuum and subsequently passing in nitrogen and is then refluxed for 22 h. After cooling, filtration is effected and the solvent is stripped off in a rotary evaporator. The product is purified by chromatography over silica gel (CH₂Cl₂/methanol 98.5:1.5). A yellow solid which phosphoresces yellow under a UV lamp is obtained.

Yield: 175 g (69% of theory)

Melting point: 221° C. (decomposition)

Characterization: ¹H-NMR (400 MHz, CDCl₃, TMS).

### Example 3-d

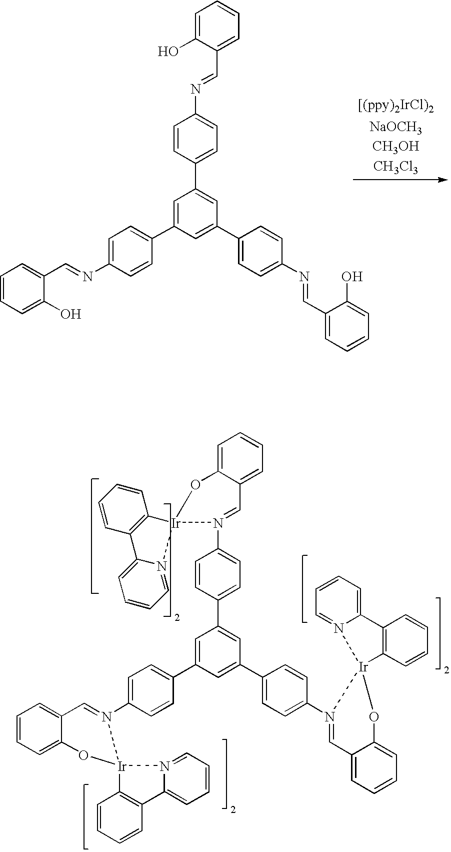

Under a nitrogen atmosphere, 13.5 g (0.25 mmol) of sodium methanolate in 1 ml of methanol are initially introduced into a carefully heated flask. 40 mg (0.06 mmol) of Schiff's base from Example 2-h and 100 mg (0.094 mmol) of iridium complex ((ppy)₂Ir(μ-Cl)₂Ir(Ppy)₂) in 25 ml of chloroform are added while stirring and refluxing is then effected for 14 h. After cooling, filtration and concentration are effected and chromatography is carried out over silica gel (CH₂Cl₂:CH₃OH 97:3). The product fractions are concentrated, hexane is added until precipitation begins and storage is effected overnight in a refrigerator. After filtration with suction and drying, a yellow-orange solid which phosphoresces orange under a UV lamp (366 nm) is obtained.

Yield: 91.5 mg (71% of theory)

Melting point: 344° C. (decomposition)

Characterization: ¹H-NMR (400 MHz, CDCl₃, TMS)

MALDI-TOF (matrix): C₁₁H₇₈N₉O₃Ir₃: M⁺ calc.: 2162.5; found 2162.4

### Example 3-e

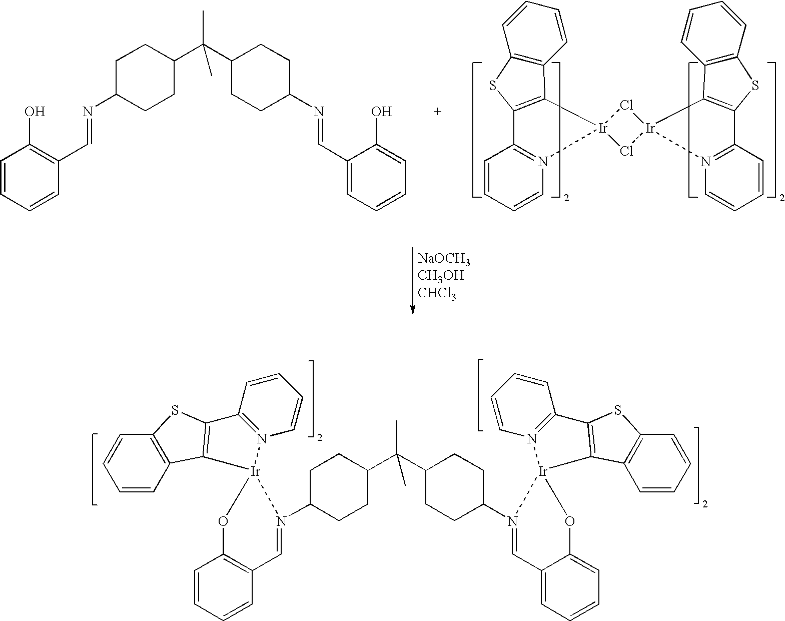

The procedure is analogous to Example 3-c with 40 mg (0.09 mmol) of Schiff's base from example 2-c, 127 mg (0.099 mmol) of iridium complex ((bthpy)₂Ir(μ-Cl)₂Ir(bthpy)₂), 10.8 mg (0.2 mmol) of sodium methanolate, 1 ml of methanol and 35 ml of chloroform. Reaction time: 13.5 h, chromatography over silica gel with CH₂Cl₂:CH₃OH 98.5:1.5. An orange solid which phosphoresces red under the UV lamp (366 nm) is obtained.

Yield: 49.5 mg (33% of theory)

Melting point: 302° C. (decomposition)

Characterization: ¹H-NMR (400 MHz, CDCl₃, TMS)

MALDI-TOF (matrix): C₈₁H₆₈N₆O₂S₄Ir₂: M⁺ calc.: 1670.1; found: 1670.2.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Polynuclear metal complexes of the general formula (I)
(LₘMe-H_{L})ₙ—X_{L} (I)
characterized in that
Me represents a transition metal,
L represents a bidentate chelate-forming ligand,
H_{L} represents a bidentate chelate-forming ligand which complexes the transition metal Me and is additionally bonded to a linker X_{L},
X_{L} represents an n-functional linker and is covalently bonded to n auxiliary ligands H_{L},
n represents an integer from 2 to 6 and
m represents an integer from 1 to 3.

2. Polynuclear metal complexes according to claim 1, characterized in that
L represents a bidentate chelate-forming ligand selected from the general formulae (II) to (XIX) 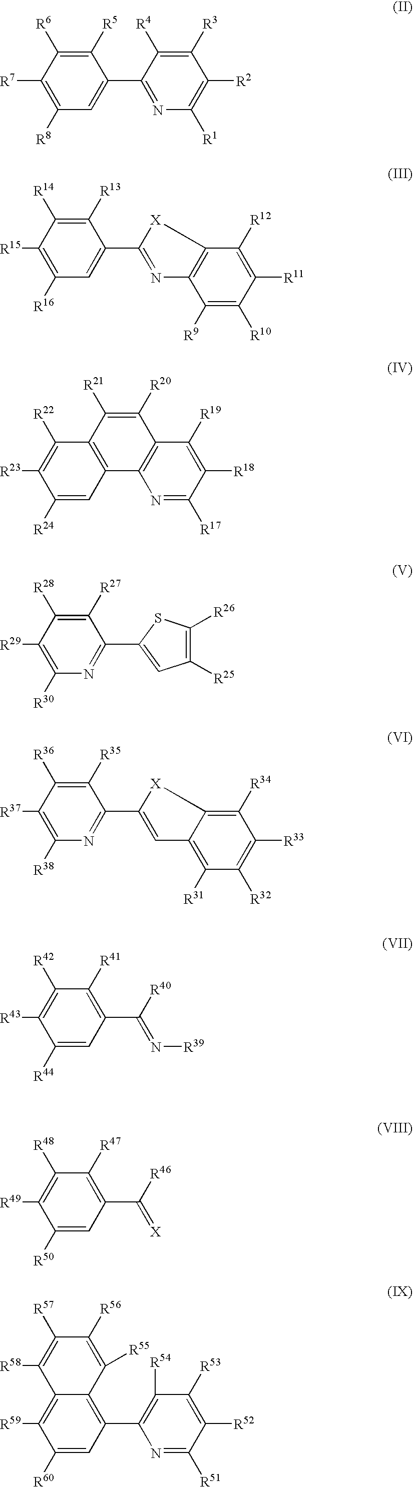 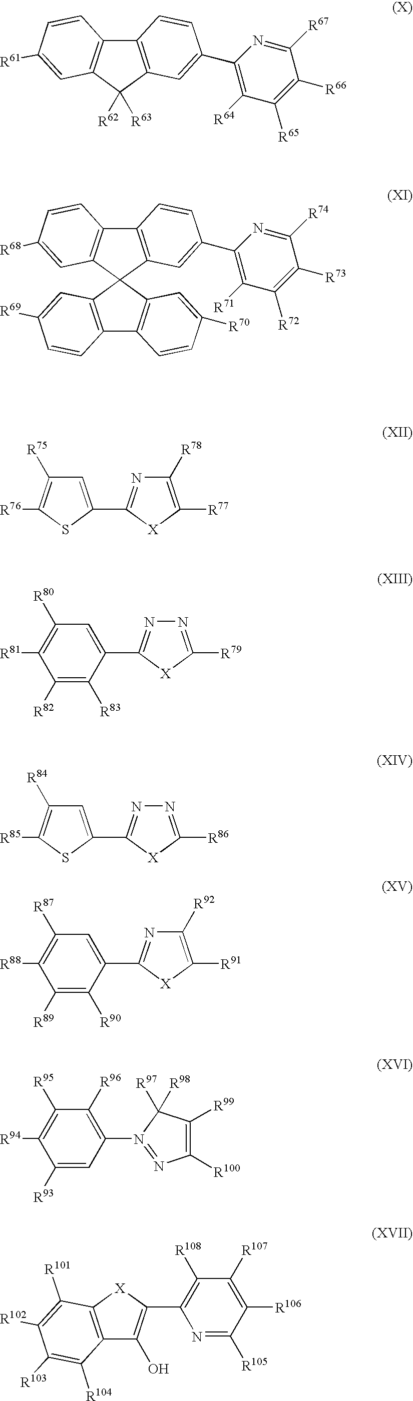 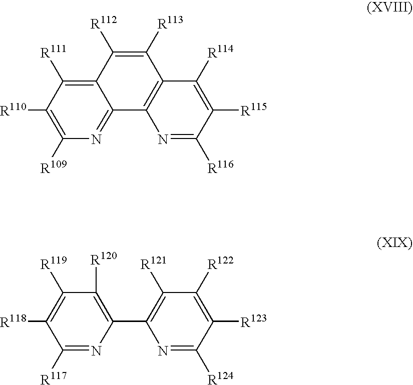
in which
X represents oxygen, sulphur, N-alkyl or N—H,
R¹-R¹²⁴ are identical or different and, independently of one another, represent H, F, CF₃, a linear or branched C₁-C₂₂-alkyl group, a linear or branched C₁-C₂₂-alkoxy group, an optionally C₁-C₃₀-alkyl-substituted C₅-C₂₀-aryl unit or an optionally C₁-C₃₀-alkyl-substituted heteroaryl unit having 5 to 9 ring C atoms and 1 to 3 ring heteroatoms from the group consisting of nitrogen, oxygen and sulphur,
H_{L} represents a bidentate chelate-forming ligand selected from the general formulae (XX) to (X) which complexes the transition metal Me and is bonded to the linker X_{L} via the linkage point marked with * 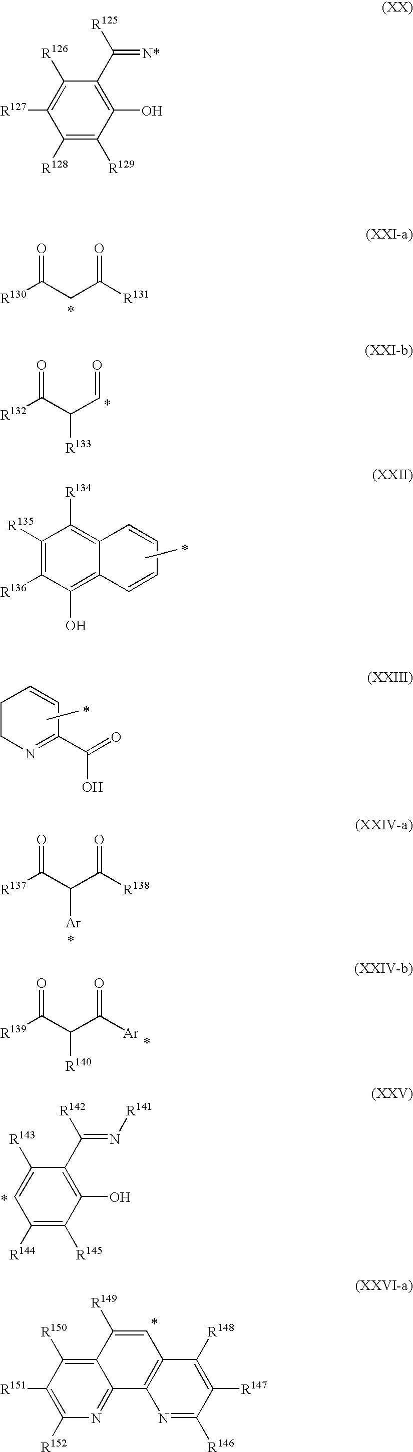 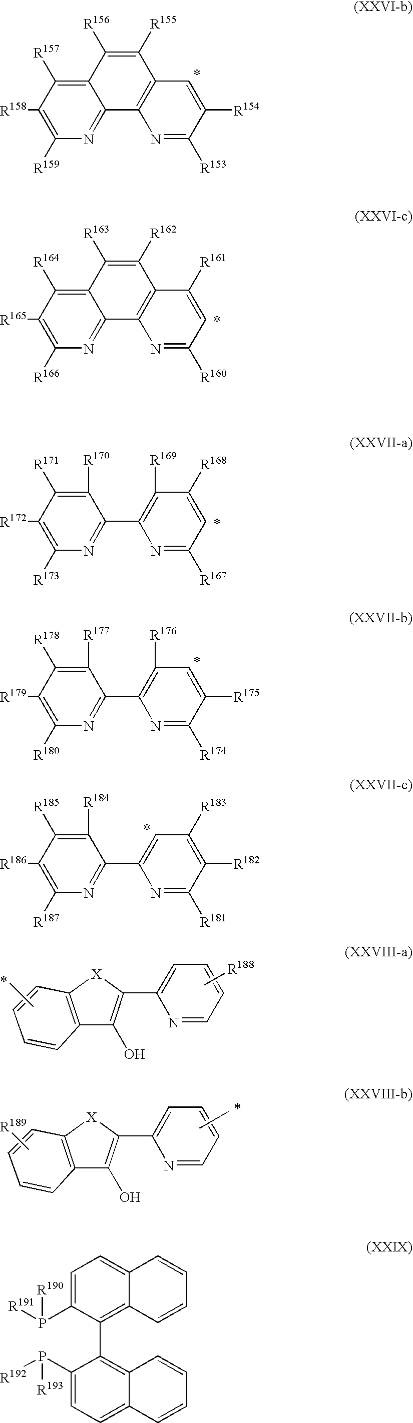 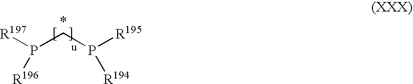
and
X represents oxygen, sulphur, N-alkyl or N—H,
u represents an integer from 1 to 6,
Ar represents phenyl, thienyl, fluorenyl, pyrrole, carbazole or 1,4-phenylene-vinylene, each of which is substituted by a linear or branched C₁-C₃₀-alkyl, C₁-C₃₀-alkoxy, F, cyano or CF₃,
R¹²⁵-R¹⁹⁷ are identical or different and, independently of one another, represent H, F, CF₃, a linear or branched C₁-C₂₂-alkyl group, a linear or branched C₁-C₂₂-alkoxy group, an optionally C₁-C₃₀-alkyl-substituted C₅-C₂₀-aryl unit or an optionally C₁-C₃₀-alkyl-substituted heteroaryl unit having 5 to 9 ring C atoms and 1 to 3 ring heteroatoms from the group consisting of nitrogen, oxygen and sulphur and
Me, X_{L} and n have the meaning stated in claim 1.

3. Polynuclear metal complexes according to claim 1, characterized in that
X_{L} is an n-functional linker selected from the following general formulae (XXXI) to (XXXXVI) 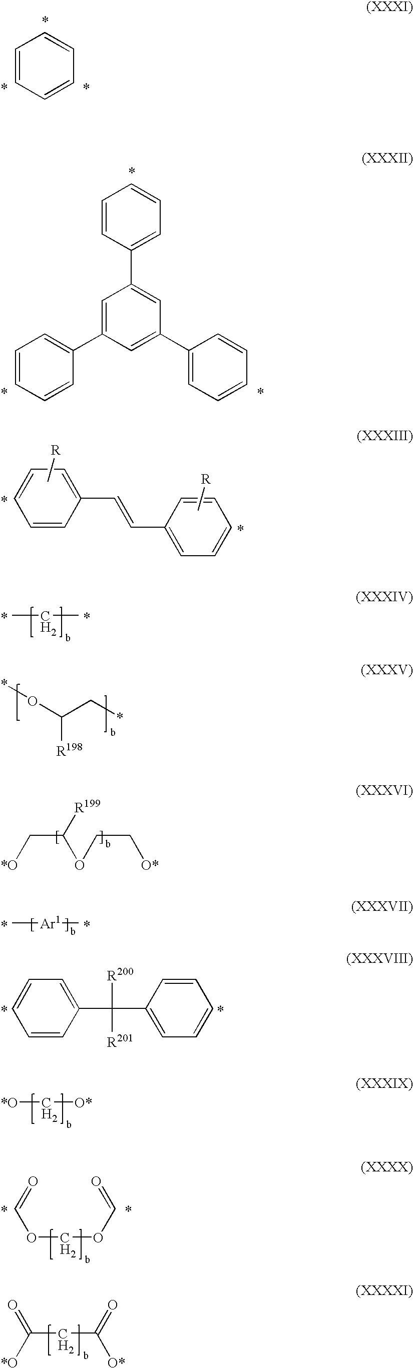 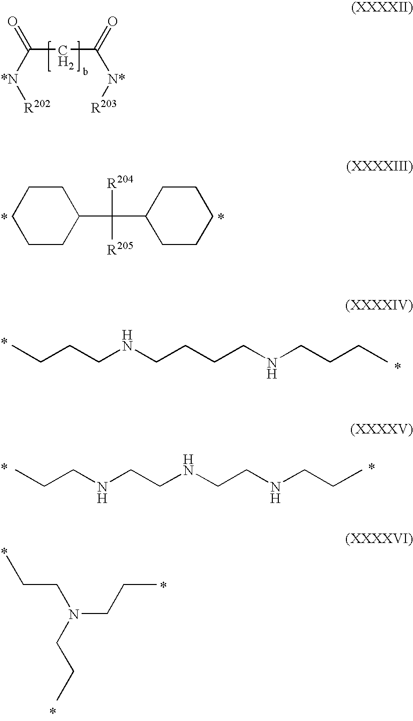
in which
b represents an integer from 2 to 300,
R¹⁹⁸-R²⁰⁵ are identical or different and, independently of one another, represent H or linear or branched C₁-C₃₀-alkyl, and
Ar¹ represents phenyl, thienyl, fluorenyl, pyrrole, carbazole or 1,4-phenylene-vinylene, each of which is substituted by a linear or branched C₁-C₃₀-alkyl or C₁-C₃₀-alkoxy group, F, cyano or CF₃, or
X_{L} represents α,ω-alkyl, α,ω-oligoethyleneoxy, α,ω-arylene, α,ω-oligoester, α,ω-oligoether, α,ω-dioxyalkyl, α,ω-dioxy-poly- and α,ω-dioxy-oligoester or the corresponding polyacrylate-, polyester- or polyether-polyols or represents linear and branched aliphatic α,ω-polycarbonate polyesters,
X_{L} being linked to H_{L} optionally via an ester, ether, amido, amino, imino, carbonate or urethane group.

4. Polynuclear metal complexes according to claim 1, characterized in that
Me represents a transition metal of the 6th to 8th subgroup, of the lanthanoid group or of the actinoid group,
n is equal to 2 or 3 and
L, H_{L} and X_{L} have the meaning stated in claim 1.

5. Polynuclear metal complexes according to claim 1, characterized in that they are selected from the general structures (Ia) to (Ih) 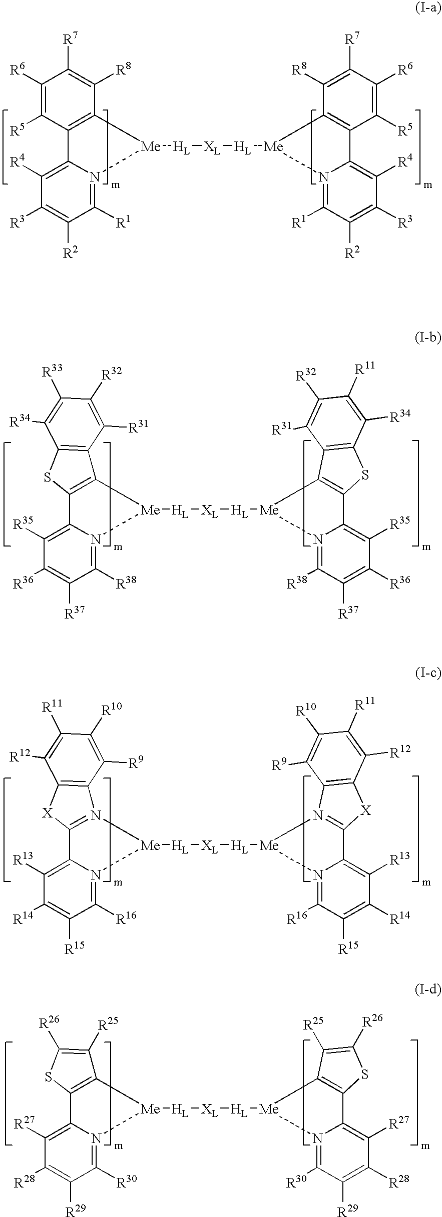 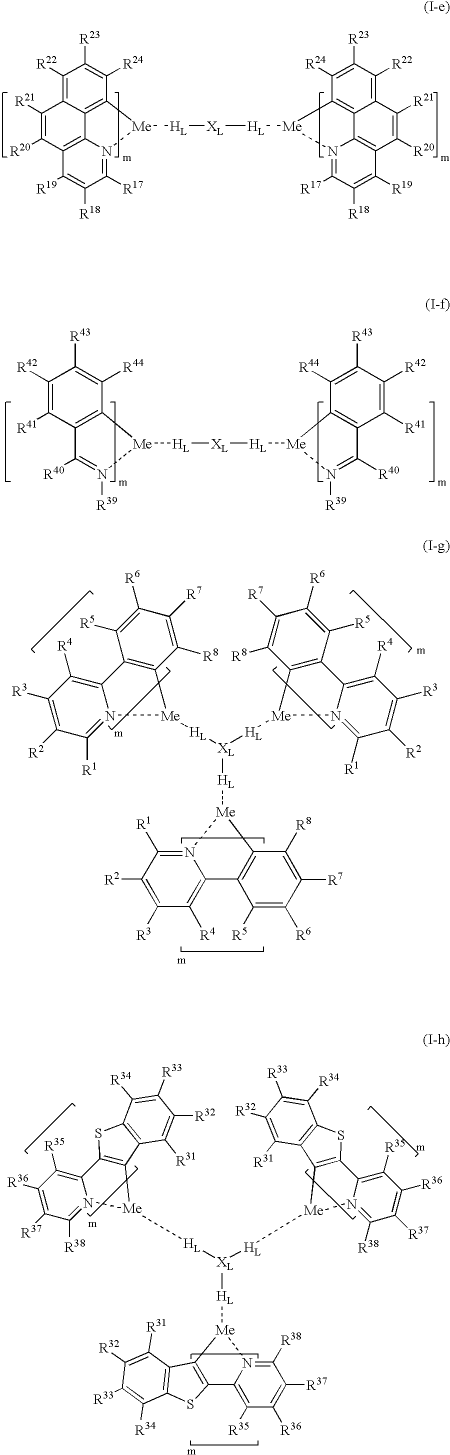
in which
Me represents platinum(II) or iridium(III),
m represents 1 or 2 and
X, R¹-R⁴⁴, H_{L} and X_{L} have the meaning stated in claim 1.

6. Process for the preparation of polynuclear metal complexes according to claim 1, comprising reacting compounds of the general formula (A) 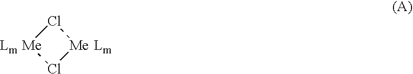
with an n-functional ligand X_{L}(H_{L})ₙ, containing n auxiliary ligands H_{L},
each of which is bidentate, with addition of a base,
m, Me, L, X_{L}, H_{L} and n having the meaning stated in claim 1.

7. Process according to claim 6, characterized in that
Me represents platinum(II) or iridium(III),
m represents 1 or 2 and
Na₂CO₃, K₂CO₃ or sodium methanolate is added as the base.

8. A process for preparing light-emitting components comprising incorporating the polynuclear metal complexes according to claim 1 as phosphorescence emitters.

9. Electroluminescent layer arrangement containing one or more layers selected from the group consisting of the hole-injecting, hole-conducting, light-emitting, hole-blocking, electron-transporting or electron-injecting layers, characterized in that the light-emitting layer contains polynuclear metal complexes according to claim 1 as phosphorescence emitters.

10. Electroluminescent layer arrangement according to claim 9, characterized in that the polynuclear metal complexes are embedded as dopants in a low molecular weight or polymeric matrix or in such a matrix composed of low molecular weight and polymeric components.

11. Electroluminescent layer arrangement according to claim 10, characterized in that the matrix contains 0.1 to 30.0 percent by weight of the polynuclear metal complexes.

12. Electroluminescent layer arrangement according to claim 10, characterized in that, where it is polymeric, the matrix is based on poly-N-vinylcarbazoles (PVK), poly-2,7-fluorenes (PF), poly-para-phenylenes (PPP), 4,4′-N,N′-dicarbazolebiphenyl (CBP) or a mixture of at least one of these polymers and 2-(4-biphenylyl)-5-(4-tert-butylphenyl)-1,3,4-oxadiazole (PBD) or, where it is of low molecular weight, the matrix is based on 4,4′-N,N′-dicarbazolebiphenyl (CBP) or of a hole-conducting material based on aromatic tertiary amines, or is composed of a mixture of these compounds with 2-(4-biphenylyl)-5-(4-tert-butylphenyl)-1,3,4-oxadiazole (PBD).

13. Electroluminescent layer arrangement according to claim 9, characterized in that the hole-blocking layer contains of 2,9-dimethyl-4,7-diphenyl[1,10]phenanthroline (BCP, bathocuproin), bis(2-methyl-8-hydroxyquinolinato)gallium chloride (Ga(qa)₂Cl), Ga(qa)₂F, Ga(qa)₂—O—Ga(qa)₂ or 3-(4-biphenylyl)-4-phenyl-5-tert-butyl-phenyl-1,2,4-triazole (TAZ).

14. Electroluminescent layer arrangement according to claim 9, characterized in that the hole-injecting layer contains a cationic polythiophene of the general formula (B) 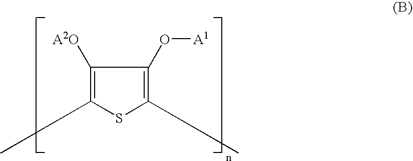
in which
A¹ and A², independently of one another, represent optionally substituted (C₁-C₁₈)-alkyl or together form optionally substituted (C₁-C₁₈)-alkylene and
n represents an integer from 2 to 10 000, preferably 3 to 5 000.

15. Electroluminescent layer arrangement according to claim 9, characterized in that the hole-conducting layer contains an aromatic amine of the formula (C) 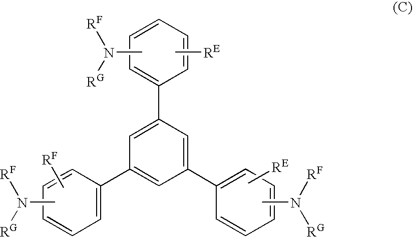
in which
R^{E} represents hydrogen, optionally substituted alkyl or halogen and
R^{F} and R^{G}, independently of one another, represent optionally substituted (C₁-C₁₀)-alkyl, alkoxycarbonyl-substituted (C₁-C₁₀)-alkyl, or aryl, aralkyl or cycloalkyl, each of which is optionally substituted.

16. Electroluminescent layer arrangement according to claim 9, characterized in that the electron-transporting layer contains a gallium complex from the group consisting of Ga(qa)₂—OR^{H}, Ga(qa)₂—OCOR^{H} or Ga(qa)₂—O—Ga(qa)₂,
R^{H} representing substituted or unsubstituted alkyl, alkenyl, aryl, arylalkyl or cycloalkyl and (qa) representing

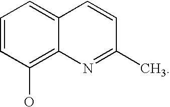

17. Process for the production of electroluminescent layer arrangements according to claim 9, characterized in that the light-emitting layer containing polynuclear metal complexes according to claim 1 is applied from solution.

18. Process for the production of electroluminescent layer arrangements according to claim 10, characterized in that the polynuclear metal complexes according to claim 1 are applied together with the matrix from solution.

19. Light-emitting components, characterized in that they contain an electroluminescent layer arrangement according to claim 9.
